(19) United States
(12) Patent Application Publication
(10) Pub. No.: US 2013/0146728 A1
(43) Pub. Date: Jun. 13, 2013

(54) Bifocal Display Positioning Apparatus and Method

(71) Applicants: Mustafa A. Ergun, Plymouth, MN (US); Shaun C. Lindblad, Lino Lakes, MN (US); Saeb Asamarai, Columbia Heights, MN (US); Kevin Paulsen, Eagan, MN (US)

(72) Inventors: Mustafa A. Ergun, Plymouth, MN (US); Shaun C. Lindblad, Lino Lakes, MN (US); Saeb Asamarai, Columbia Heights, MN (US); Kevin Paulsen, Eagan, MN (US)

(73) Assignee: ERGOTRON, INC., St. Paul, MN (US)

(21) Appl. No.: 13/371,699

(22) Filed: Feb. 13, 2012

Related U.S. Application Data
(60) Provisional application No. 61/441,774, filed on Feb. 11, 2011.

(51) Int. Cl. F16M 13/02

(52) U.S. Cl. CPC F16M 13/022
USPC 248/291.1; 248/299.1

(57) ABSTRACT

An apparatus for positioning items such as an electronic display, a keyboard, and/or a work surface. The apparatus includes a movement mechanism that provides multiple tilt positions for one or more displays supported by the apparatus. In some cases the movement mechanism enables adjustment of the display(s) between a generally horizontal viewing configuration and a generally declining viewing configuration. In some cases the apparatus includes a keyboard tray and a display mount coupled to a riser adapted to support an electronic display. The riser may be movable with respect to an operator or support member between a sitting position and a standing position. Methods for positioning an electronic display and a keyboard are also included.

### CROSS-REFERENCES

This application claims the benefit of U.S. Provisional Application No. 61/441,774, filed Feb. 11, 2011, the content of which is hereby incorporated by reference in its entirety.

### FIELD

Embodiments of the invention generally relate to devices that can move work surfaces and/or equipment such as electronic displays, keyboards, and other items between multiple positions relative to an operator.

### BACKGROUND

Many jobs involve working at desks, optionally with personal computers and/or display monitors. In such jobs, the personal computers and/or display monitors may be used by multiple operators at different times during a day. In some settings, one computer and/or monitor may be used by multiple people of different sizes and having different preferences in a single day. Given the differences in people's size and differences in their preferences, a monitor or display adjusted at one setting for one individual may be inappropriate for another individual. The same can be true for the position of the desk surface itself. For instance, a child would have different physical space needs than an adult using the same computer and monitor. As another example, a user wearing bifocal lenses would require different display tilt settings than a user without bifocal lenses. Further, a single user may wish to periodically both sit and stand while using the desk surface and/or monitor. In some situations, users desire to perform operations in various postures. For example, one may desire to perform some operations in a seated position and others in a standing position. In such situations, it may be required that both the seated operations and the standing operations be done at the same workstation, which may include a desk surface, computer monitor, a keyboard, and/or a mouse. Such a user will desire the desk surface, monitor and/or other equipment to be at different heights while sitting and standing.

As adjustable height mechanisms for displays have become more widespread and users have experienced their advantages, users are more frequently adjusting the height of their monitors and other equipment. Further, such adjustments are now more frequently desired over a wide range of travel.

### SUMMARY

Embodiments of the invention are generally directed to devices that can electronic displays and optionally other items such as keyboards, work surfaces, etc., between multiple positions relative to an operator. One example of a device provides at least a first configuration with a generally horizontal viewing configuration and a second configuration with a generally declining viewing configuration. Switching from the first configuration to the second configuration enables an operator to view an electronic display in a generally declining orientation (e.g., looking ahead and downward), which can be useful for operators wearing bifocal lenses.

According to one aspect of the invention, an apparatus for positioning an electronic display includes a riser, a movement mechanism coupled to the riser, and a display mount coupled to the movement mechanism and the riser. The riser includes a support column and a bracket movably coupled together and a first lift mechanism coupled between the support column and the bracket. The display mount is adapted to support an electronic display, such as a computer monitor, television, touch screen, and other such devices. Relative movement between the bracket and the support column provides simultaneous height adjustment of the movement mechanism and the display mount. At each height, the display mount can be configured in a first configuration that provides a generally horizontal viewing configuration and a second configuration that provides a generally declining viewing configuration. The movement mechanism provides the display mount with at least a first position relative to the riser and a second position relative to the riser. The movement mechanism and the display mount provide a supported electronic display in the first position with a maximum backward tilt to provide the generally horizontal viewing configuration. They also provide a supported electronic display in the second position with a maximum backward tilt of at least 30 degrees to provide the generally declining viewing configuration. The maximum backward tilt in the first position is smaller than the maximum backward tilt in the second position.

According to another aspect of the invention, an apparatus for positioning an electronic display and a keyboard is provided. The apparatus includes a riser, a movement mechanism coupled to the riser, a display mount coupled to the movement mechanism, and a keyboard tray coupled to the riser. The riser includes a support column and a bracket movably coupled together and a first lift mechanism coupled between the support column and the bracket. Relative movement between the bracket and the support column provides simultaneous height adjustment of the movement mechanism, the display mount, and the keyboard tray. At each height provided by the riser, the movement mechanism provides the display mount with a first position relative to the riser in the first configuration and a second position relative to the riser in the second configuration. In the first position, the movement mechanism and the display mount provide a supported electronic display with a maximum backward tilt to provide the generally horizontal viewing configuration. In the second position, the movement mechanism and the display mount provide a supported electronic display with a maximum backward tilt to provide the generally declining viewing configuration. The maximum backward tilt in the second position is greater than the maximum backward tilt in the first position.

Another aspect of the invention provides an apparatus for positioning an electronic display and a keyboard. The apparatus includes a riser, a keyboard tray coupled to the riser, adapted to support a keyboard, a movement mechanism coupled to the riser, and a display mount coupled to the movement mechanism and adapted to support an electronic display. The riser provides simultaneous height adjustment of the movement mechanism, the display mount, and the keyboard tray between a sitting height and a standing height, thus providing a sit-to-stand apparatus. At each of at least two heights provided by the riser, the display mount and the keyboard tray are configurable in a first configuration providing a generally horizontal viewing configuration and a second configuration providing a generally declining viewing configuration. In the second configuration a vertical distance between the display mount and the keyboard tray is different than in the first configuration. The movement mechanism provides the display mount with a first position relative to the riser in the first configuration and a second position relative to the riser in the second configuration. In the second position the display mount and the display can tilt back from a vertical orientation to a greater degree than is available in the first position.

Accordingly to another aspect of the invention, a method for positioning an electronic display and a keyboard is provided. The method includes supporting an electronic display with a positioning apparatus. The positioning apparatus includes a riser, a display mount coupled to the riser and adapted to support the electronic display, a keyboard tray coupled to the riser, and a movement mechanism coupled between the riser and the display mount. The method also includes supporting a keyboard with the keyboard tray. The riser is adjusted to simultaneously adjust the height of the display mount, the electronic display, the keyboard tray, the keyboard, and the movement mechanism between a sitting position and a standing position. At both the sitting position and the standing position, the method includes configuring the display mount and the keyboard tray in a first configuration to provide a generally horizontal viewing configuration and a second configuration to provide a generally declining viewing configuration. In the second configuration a vertical distance between the display mount and the keyboard tray is less than in the first configuration. In addition, the movement mechanism provides the display mount with a first position relative to the riser in the first configuration and a second position relative to the riser in the second configuration. In the second position the display mount and the display can tilt back from a vertical orientation to a greater degree than in the first position.

These and various other features and advantages will be apparent from a reading of the following detailed description.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1A is a side view of a positioning apparatus.

FIG. 1B is a side cross-section of FIG. 1A.

FIGS. 2A-2C are perspective views of positioning apparatuses with various mounting options.

FIG. 3 is a side cross-sectional view of a keyboard tray.

FIG. 4 is a side cross-sectional view of a portion of a lift mechanism.

FIG. 5 is an enlarged view of a lift mechanism shown in FIG. 1B.

FIG. 6 is an enlarged view of a second lift mechanism shown in FIG. 1B.

FIG. 7A is a perspective view of a screw clamp.

FIG. 7B is a top view of the screw clamp of FIG. 7A.

FIG. 7C is a front view of the screw clamp of FIG. 7A.

FIG. 7D is a bottom view of the screw clamp of FIG. 7A.

FIG. 7E is a side view of the screw clamp of FIG. 7A.

FIG. 8A is a perspective view of a screw clamp.

FIG. 8B is a top view of the screw clamp of FIG. 8A.

FIG. 8C is a front view of the screw clamp of FIG. 8A.

FIG. 8D is a bottom view of the screw clamp of FIG. 8A.

FIG. 8E is a side view of the screw clamp of FIG. 8A.

FIG. 9 is a perspective view of a c-clamp.

FIG. 10A is a side view of a c-clamp in a first configuration.

FIG. 10B is a side view of a c-clamp in a second configuration.

FIG. 11 is a side view of a c-clamp attached to a support surface.

FIGS. 12A and 12B are front perspective views of a positioning apparatus in a lowered position and a raised position, respectively.

FIGS. 13A and 13B are rear perspective views of a positioning apparatus in a lowered position and a raised position, respectively.

FIG. 14 is a perspective view of an apparatus.

FIG. 15 is a partially exploded view of the apparatus of FIG. 14.

FIGS. 16A and 16B are partial, exploded views of a bottom portion of the apparatus of FIG. 14.

FIG. 17 is a partial elevation view of a top portion of an apparatus.

FIG. 18 is a perspective view of a bottom portion of an apparatus.

FIGS. 19A and 19B are perspective views of a cam member including a first cam and a second cam.

FIG. 20 is a side plan view of the cam member of FIG. 19A.

FIG. 21 is a perspective view of a wheel pulley.

FIG. 22 is a side plan view of the wheel pulley of FIG. 21.

FIG. 23 is a perspective view of a pulley system.

FIG. 24 is a side plan view of the pulley system of FIG. 23.

FIG. 25 is a perspective view of a portion of a balance mechanism in a state corresponding to a first position of a mounting portion.

FIG. 26 is a perspective view of a portion of a balance mechanism in a state corresponding to a second position of a mounting portion.

FIG. 27 is a side schematic view of a positioning apparatus in accordance with an embodiment of the invention.

FIG. 28A is a side schematic view of a positioning apparatus in accordance with an embodiment of the invention.

FIG. 28B is a side schematic view of a positioning apparatus in accordance with an embodiment of the invention.

FIGS. 29A-29B are side schematic views of a positioning apparatus in accordance with an embodiment of the invention.

FIG. 29C is a side schematic view of a positioning apparatus in accordance with an embodiment of the invention.

FIG. 30 is a side schematic view of a positioning apparatus in accordance with an embodiment of the invention.

FIG. 31 is a side schematic view of a positioning apparatus in accordance with an embodiment of the invention.

FIG. 32A is a side schematic view of a positioning apparatus in accordance with an embodiment of the invention.

FIG. 32B is a side schematic view of a positioning apparatus in accordance with an embodiment of the invention.

FIGS. 33A and 33B are side schematic views of a positioning apparatus in accordance with embodiments of the invention.

FIG. 34A is a side schematic view of a positioning apparatus in accordance with an embodiment of the invention.

FIG. 34B is a side schematic view of a positioning apparatus in accordance with an embodiment of the invention.

FIG. 35A is a side schematic view of a positioning apparatus in accordance with an embodiment of the invention.

FIG. 35B is a side schematic view of a positioning apparatus in accordance with an embodiment of the invention.

FIG. 36 is a side schematic view of a positioning apparatus in accordance with an embodiment of the invention.

FIG. 37 is a perspective view of a positioning apparatus in accordance with an embodiment of the invention.

FIG. 38 is a perspective view of a positioning apparatus in accordance with an embodiment of the invention.

FIGS. 39A-39F are side schematic views of positioning apparatuses in accordance with embodiments of the invention.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Embodiments of the invention generally provide apparatuses capable of positioning various equipment relative to a human operator. For example, in some cases a positioning apparatus can support items such as work surfaces, electronic displays, a laptop computer (i.e., notebook), a keyboard, and/or other computing equipment, such as a mouse. As used herein, the terms display and electronic display are used to refer to televisions, computer monitors, tablet computers (e.g., touch screen computers), and other types of displays capable of displaying images from electronic signals. The embodiments discussed herein provide several examples of positioning apparatuses capable of positioning such types of computing equipment, however, it is contemplated that embodiments of the invention can be used for positioning a wide variety of items.

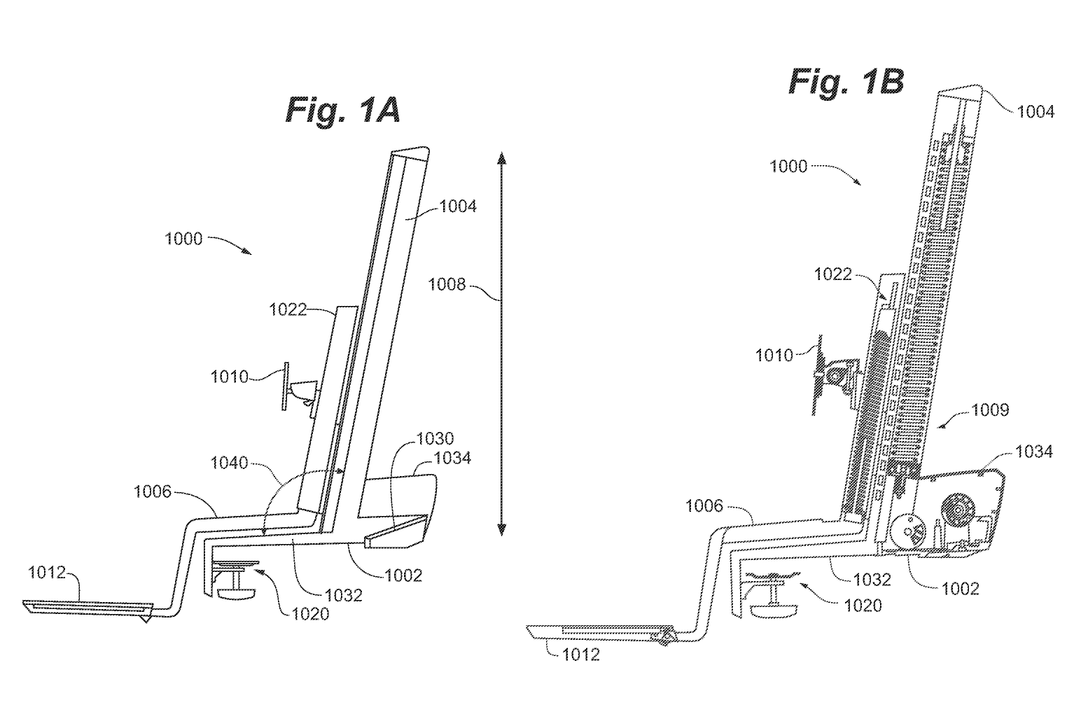

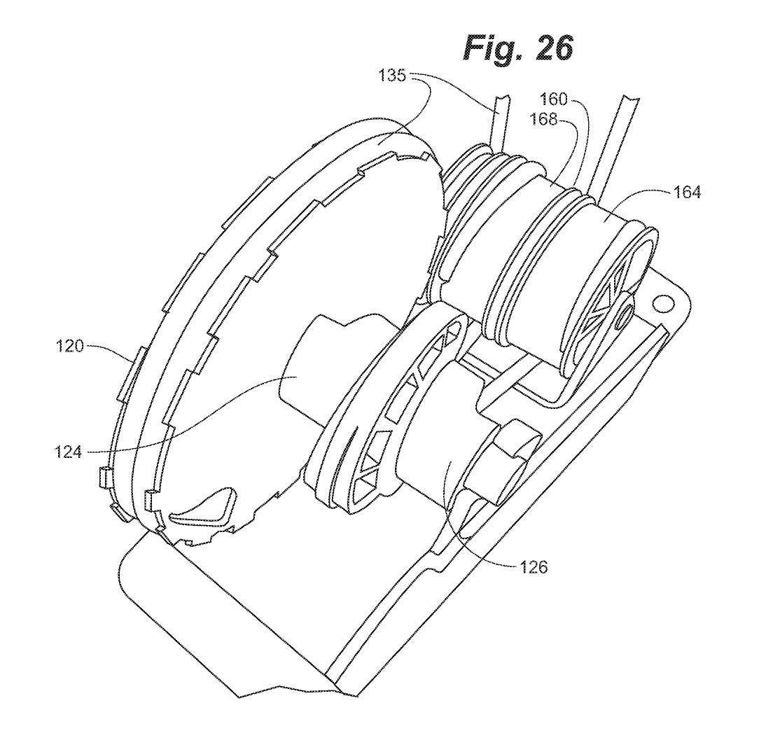

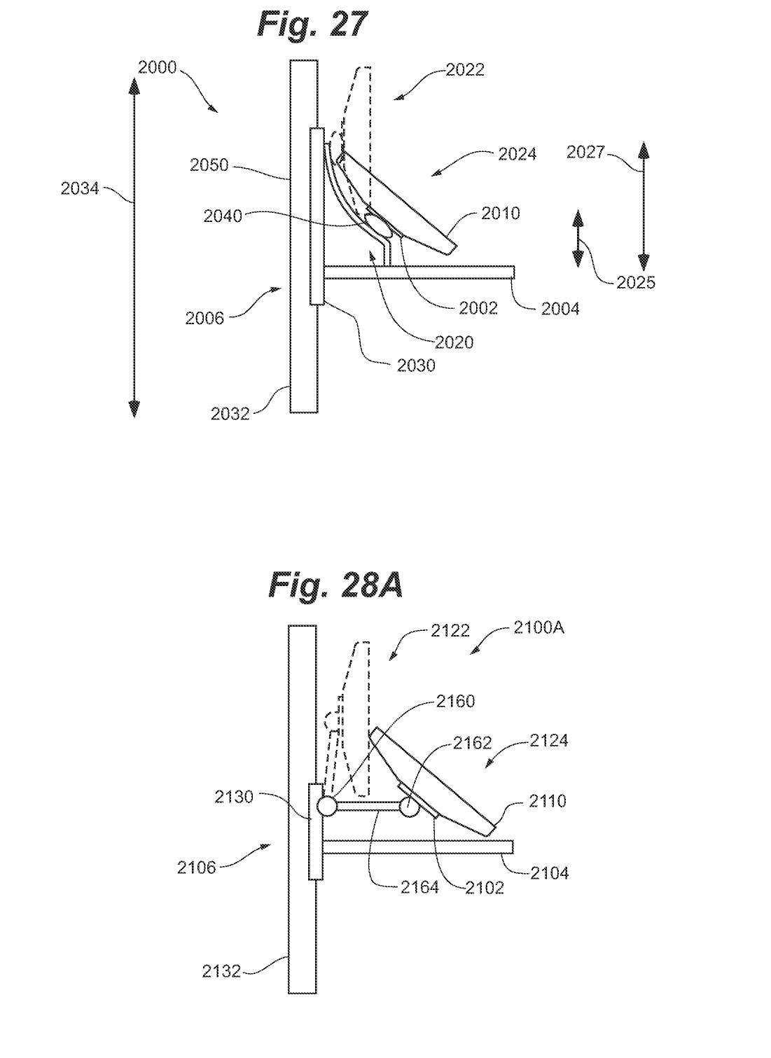

Applicants have included FIGS. 1-26 to provide background and disclosure to facilitate one of ordinary skill in the art to make and use the invention, embodiments of which are described in FIGS. 27-39F. Applicants will describe FIGS. 1-26 in detail below.

FIG. 27 is a side schematic view of a positioning apparatus 2000 in accordance with an embodiment of the invention. The positioning apparatus 2000 includes a display mount 2002 and a keyboard tray 2004 both coupled to a riser 2006. Although not shown, the riser 2006 is adapted to be supported in a generally vertical orientation by an existing support member (e.g., a table, bench, wall, etc.). The riser 2006 supports the display mount 2002 and the keyboard tray 2004, along with a supported (e.g., attached) display 2010 and a keyboard (not shown), and provides simultaneous height adjustment of the display mount 2002, the display 2010, the keyboard tray 2004, and the keyboard through a generally vertical range of travel 2034 relative to a user. In some cases the apparatus 2000 is vertically adjustable to an infinite number of positions along the extent of the available height adjustment.

As will be discussed further herein, the display mount 2002 and the keyboard tray 2004 are configurable in multiple viewing configurations at each height provided by the riser 2006. In certain embodiments the display mount 2002 and the keyboard tray 2004 are configurable in at least a first configuration that provides a generally horizontal viewing configuration and a second configuration that provides a generally declining viewing configuration. Switching from the first configuration to the second configuration enables an operator to view the display 2010 in a generally declining orientation (e.g., looking ahead and downward), which can be useful for operators wearing bifocal lenses.

The positioning apparatus 2000 also includes a movement mechanism 2020, which couples the display mount 2002 to the riser 2006. The movement mechanism 2020 provides multiple positions for the display mount 2002 and the attached display 2010 relative to the riser 2006 and an operator. In this example the movement mechanism 2020 provides at least a first position 2022 (shown with the display illustrated in phantom) relative to the riser in the first viewing configuration. The movement mechanism 2020 also provides at least a second position 2024 relative to the riser 2006 in the second viewing configuration. In this case the second position 2024 is located at a greater horizontal distance from the riser 2006 than the first position 2022, though this is not required. The second configuration also provides a vertical distance 2025 between the display mount 2002 and the keyboard tray 2004 that is less than the vertical distance 2027 provided by the first configuration. In this case configuring the apparatus 2000 in the second configuration includes moving the display mount 2002 and the display 2010 from the first position 2022 to the second position 2024, which enables an operator to view the display 2010 in a generally declining orientation.

The riser 2006 generally provides height adjustment, and can include any suitable mechanism for simultaneously raising and lowering the display mount 2002 and the keyboard tray 2004. In the examples illustrated in the figures, the riser includes a support column and a bracket, though other forms of risers can also be used. As shown in FIG. 27, the riser 2006 includes a bracket 2030 moveably coupled with a support column 2032. The riser support column 2032 and the riser bracket 2030 are movably coupled through a generally vertical range of travel 2034, providing the display 2010 and keyboard tray 2004 with height adjustability relative to an operator. For example, in some cases rollers, slides, and optionally a lift mechanism (not shown) are provided to movably couple the support column 2032 and the riser bracket 2030. The generally vertical range of travel 2034 allows the positioning apparatus 2000 to move various items, including for example, the display 2010 and keyboard tray 2004 relative to the operator. Accordingly, the positioning apparatus 2000 can allow an operator to simultaneously adjust the height of multiple pieces of equipment.

Mounting the positioning apparatus 2000 on or to an existing stationary support member (e.g., a work surface) can thus provide a multi-position workstation for one or multiple operators. In many cases the apparatus 2000 also includes a base or an attachment member (not shown) coupled to the riser 2006 for supporting and/or attaching the riser 2006 to a support member. The positioning apparatus 2000 can be advantageously adapted to be supported by or attached to a wide variety of support members. For example, in some cases the support member is a floor, wall, or an existing work surface such as a desk, table, tray, counter, or another type of furniture. As used herein, the term “work surface” is used to refer to both the outermost top surface of such articles, as well as the top planar member (e.g., table top or desk top) having a thickness and one or more edges. In some embodiments the support member may be part of a cubicle or other office furniture. In general, the support member has a generally planar, horizontal surface and one or more edges. The support member provides a platform for mounting the positioning apparatus 2000, and in some cases may be referred to as a mounting platform. Examples of support members, bases, and attachment members are described in more detail with respect to, e.g., FIGS. 34-35, 37-39, and FIGS. 1-26.

In some cases the support member is horizontal and substantially parallel to a floor. In certain embodiments, however, the positioning apparatus 2000 may be adapted to be attached to a slightly inclined support member (e.g., an inclined desktop). The positioning apparatus 2000 provides a range of travel for simultaneously moving various items, including computer monitors and keyboards, relative to the support member. Accordingly, the positioning apparatus 2000 can allow an operator to adjust the height of equipment relative to the support member and the operator. Supporting and/or mounting the positioning apparatus 2000 to such a support member can thus convert or transform a normally single-position (e.g., stationary or fixed-height) workstation into a multi-position workstation.

One example of a contemplated use for the positioning apparatus 2000 includes transforming a traditional, stationary computer workstation into a multi-position (e.g., multi-height) computer workstation. In many traditional settings, computer workstations generally include a monitor and keyboard simply resting on an existing work surface such as a desk or table. While the positions of the monitor and the keyboard in such settings may sometimes be adjusted by small amounts relative to the work surface, computer operators are generally limited to a single working position by the height of the existing work surface. For example, a traditional desk may only accommodate sitting positions. According to some embodiments of the invention, the positioning apparatus 2000 can transform such a traditional, fixed height computer workstation into a multi-position (e.g., multi-height) computer workstation, allowing an operator to adjust the height of the workstation to accommodate multiple working positions, including a sitting position and a standing position.

The riser 2006 can be dimensioned to provide the positioning apparatus with a vertical range of travel 2034 of any desired length, thus allowing the bracket 2030 and the attached equipment to be moved through a wide range of heights. As will be appreciated, in cases where the support column 2030 is positioned at an angle with respect to a vertical orientation, the apparatus may also provide an amount of horizontal movement as the bracket 2030 moves through the vertical range of travel 2034.

In a preferred embodiment, the vertical range of travel 2034 extends between a sitting height and a standing height, thus allowing an operator to use the positioning apparatus from both a sitting position and a standing position. For example, in certain cases the vertical range of travel 2034 provides at least about 14 inches of vertical adjustment (e.g., the display/keyboard can be moved at least about 14 inches). In some cases the vertical range of travel provides between about 14 inches and about 24 inches of vertical adjustment. More than 24 inches of vertical adjustment may also be provided. In some applications, however, the vertical range of travel may provide less than 14 inches of travel. For example, in some cases the vertical range of travel may be as small as 5 inches. The riser 2006 may also provide multiple positions at intermediate heights (e.g., at an infinite number of heights) between the lowest and highest extents of the range of travel 2034, thus accommodating other working positions and/or operators of different heights. In some cases a discrete number of intermediate positions are provided. In some cases the riser 2006 provides an infinite number of intermediate positions within the vertical range of travel 2034.

Although not shown in FIG. 27, an optional lift mechanism is provided that movably couples the bracket 2030 and the support column 2032. The lift mechanism is not a required feature, but when incorporated it provides an operator with a degree of assistance to move the riser 2006 through the range of travel 2034. For example, in some embodiments an energy storage member such as an extension spring provides a biasing force that aids an operator in adjusting the height of the bracket 2030.

In certain cases, the lift mechanism includes a balance mechanism incorporating an energy storage member that can counterbalance some or all of the weight of an electronic display and/or other equipment supported by the bracket 2030. As just one example, a lift mechanism can incorporate a cam (e.g., a rotary cam) that is coupled to the energy storage member and the bracket with one or more tension members (e.g., a line, cable, rope, chain, etc.).

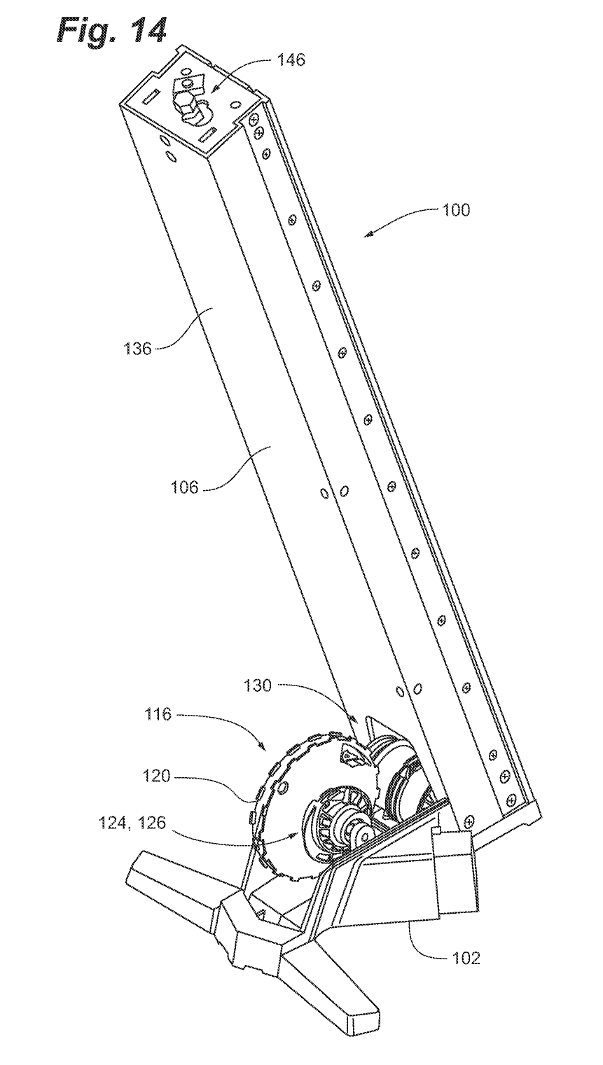

One example of a lift/balance mechanism 116 that can be adapted for use with embodiments of the present invention is described with respect to FIGS. 14-26. Another example of a balanced lift mechanism that can be adapted for use with embodiments of the present invention is described with respect to FIGS. 14-18 in presently co-owned U.S. Patent Application Publication US 2006/0185563 A1, filed Sep. 28, 2005, the entire contents of which is incorporated by reference herein. The lift mechanism may also be provided according to embodiments described in one or more of presently co-owned US Patent Application Publication US 2008/0026892 A1, filed Jul. 26, 2007; US Patent Application Publication US 2007/0259554 A1, filed May 4, 2007; U.S. Pat. No. 6,997,422, filed Aug. 20, 2003; U.S. Pat. No. 7,506,853, filed Nov. 3, 2004; and U.S. Pat. No. 6,994,306, filed Nov. 28, 2000. The entire disclosure of each of the above-mentioned patents and patent applications is hereby incorporated by reference herein.

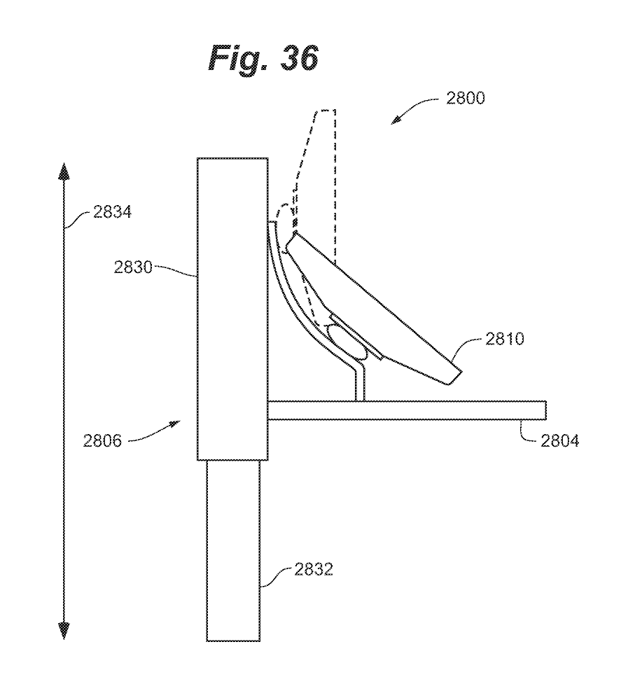

While a few examples of possible configurations for a lift/balance mechanism are described herein, it should be appreciated that a wide variety of lift mechanisms and/or balanced lift mechanisms can be used and that the scope of the invention is not limited to a particular lift configuration. For example, in some cases a lift mechanism includes a telescoping configuration (e.g., see FIG. 36). In some cases the lift mechanism includes a rotary cam coupled with an energy storage member such as an extension spring, a compression spring, a torsion spring, or a spiral spring. In some cases the lift mechanism includes a constant force spring and/or a gas spring.

Returning to FIG. 27, the positioning apparatus 2000 includes the display mount 2002 adapted to support the display 2010. As shown in FIG. 27, the display mount 2002 is coupled to the riser bracket 2030 with the movement mechanism 2020 and an optional tilt mechanism 2040. The display mount 2002, the display 2010, the movement mechanism 2020, and the keyboard tray 2004 thus move along with the riser bracket 2030 through the vertical range of travel 2034. In general, the display mount 2002 is a structural component adapted to couple with the display 2010, for attaching the display 2010 to the positioning apparatus. For example, the display mount 2002 may include a bracket designed to mate with a matching recess or bolt holes in the back of the display. In certain embodiments the display mount 2002 includes a standard display interface or connector, such as a VESA connector. Of course other mounting structure, including brackets, fasteners, and the like are known in the art and the scope of the invention is not limited in this regard. In addition, it should be noted that the positioning apparatus 2000 may be configured to position a single display, multiple displays (e.g., two or three), and/or multiple displays and a laptop.

Continuing with FIG. 27, the keyboard tray 2004 is coupled to the riser bracket 2030 below the display mount 2002. The keyboard tray 2004 is a structural component adapted support a keyboard (not shown), and can thus take many forms. In the illustrated embodiment, the keyboard tray 2004 is a flat work surface (e.g., a desk top or table) that extends out from the riser to position the keyboard in front and below the display 2010. In some cases the keyboard tray may instead be especially configured for supporting a keyboard rather than being a multipurpose work surface. As will be discussed further herein, a keyboard tray is not required in all embodiments. For example, a positioning apparatus may simply support an electronic display, such as a touch-sensitive tablet computer. Returning to FIG. 27, the combination of the riser bracket 2030, the movement mechanism 2020 and display mount 2002, and the keyboard tray 2004 provide a frame configured to support the display 2010 and the keyboard in a spaced relationship, with the keyboard set apart from the display in order to allow an operator to comfortably use the keyboard on the tray while viewing the display.

As shown in FIG. 27, the positioning apparatus 2000 includes a mounting configuration adapted to support the electronic display 2010 and a keyboard. It should be appreciated that a number of optional and/or alternative mounts and supports for attaching and otherwise supporting equipment and other items can be included. For example, any number of displays such as one, two, three or more displays can be mounted on a positioning apparatus, with or without a laptop. Some positioning apparatuses may include a fixed and/or movable tray, work surface, or platform. Some positioning apparatuses may include a document holder. Of course a wide variety of pieces of equipment can be supported by a positioning apparatus, including without limitation, an electronic display mount, a keyboard tray, a mouse tray, a document holder, a movable work surface, and a telephone holder.

The positioning apparatus 2000 also includes the movement mechanism 2020, which couples the display mount 2002 to the riser 2006. In this embodiment of the invention, the movement mechanism 2020 includes a curved rail 2050 and a bracket (e.g., integral with or attached to the optional tilt bracket 2040) that slides over the curved rail 2050 to adjust the position of the display mount 2002 and display 2010. A fastener or other brake mechanism can be used to secure the bracket and display mount at a desired position along the rail 2050. In some cases the curved rail 2050 is attached at one end to the riser bracket 2030, extends down and away from the riser 2006, and is attached at the opposite end to the keyboard tray 2004. Other mounting configurations are possible. The rail 2050 and bracket can be manufactured from any suitable material, such as metals, metal alloys, plastics, and/or composite materials.

The movement mechanism 2020 thus provides a path of travel that guides movement of the display mount 2002 and display 2010 between the first display position 2022 and the second display position 2024. The curve of the rail 2050 also tilts the display mount and the display backward as the display is moved from the first position to the second position. Accordingly, the movement mechanism 2020 provides a useful mechanism for adjusting the tilt and viewing angle of the display 2010 between the first position in the generally horizontal viewing configuration and the second position in the generally declining viewing configuration.

The inventors have found that providing a generally declining viewing configuration is especially useful for an operator wearing bifocal lenses (i.e., lenses having two or more portions with different optical powers). For example, an operator may need to view the display through a high optical power lens because his ability to focus on the display is impaired due to the short distance between the display and the operator's eyes. In a traditional configuration in which the display 2010 is in a generally horizontal viewing position (e.g., the first position 2022), the operator may thus find it necessary to crane his head and neck upward in order to see through the higher power lens, which is typically in the bottom of bifocal lenses. Moving the display mount 2002 and the display 2010 into the second position 2024 (sometimes referred to herein as the “bifocal” position/orientation) locates the display 2010, tilted back and up, in a forward, lower position closer to the keyboard tray 2004. Thus, the operator can view the display 2010 through the higher power lens potion of a bifocal lens while keeping the operator's head relatively level and neck straight.

Accordingly, moving the display 2010 into the second position 2024 with the display tilted back and upward toward the operator provides a superior ergonomic viewing configuration that has the potential to relieve neck strain and other discomfort for operators wearing bifocal lenses. In some cases the optional tilt mechanism 2040 can provide an additional measure of tilt adjustment at any given position along the rail 2050. Further, the positioning apparatus 2000 can maintain the display mount 2002 and the attached display 2010 close to the keyboard tray 2004 in the second viewing configuration at different heights of the positioning apparatus, e.g., for sitting and standing postures. The adjustability of the movement mechanism 2020 allows the display to also be adjusted to the first position 2022 in the generally horizontal viewing orientation which can be useful for operators without bifocal lenses.

As illustrated in FIG. 27, the curved rail 2050 and the tilt bracket can provide a continuous range of tilt adjustment, with an infinite number of display positions between the first position 2022 and the second position 2024. In another configuration, a curved bracket only providing a discrete number of positions may instead be used to selectively mount the display mount 2002 at one of the first and the second positions. This configuration can provide a more economical configuration, especially for single-user workstations in which the display is not often adjusted.

The location of the second display position relative to the location of the first display position may vary depending upon the dimensions of the positioning apparatus and/or the distance of the display from the operator. In certain cases the movement mechanism provides the second display position at a greater horizontal distance from the riser than the first position and at a different vertical location relative to the keyboard than the first position. Referring to FIG. 27, the second position 2024 is located generally forward of and at a lower height than the first position 2022. This location for the bifocal position usefully places the display in the lower half of an operator's field of vision without the need to separately adjust the height of the positioning apparatus, thus making it easier for the operator to view the display by merely looking downward through bifocals.

The second/bifocal position 2024 for the display 2010 generally enables the display 2010 to tilt back from a vertical orientation to a greater degree than is available in the first position 2022. In other words, the movement mechanism 2020 and the display mount 2002 provide the display in the first position with a maximum backward tilt to provide the generally horizontal viewing configuration and the display in the second position with a maximum backward tilt to provide the generally declining viewing configuration, and the maximum backward tilt in the second position is greater than the maximum backward tilt in the first position.

In some cases the spacing between the display and the riser 2006 and/or the keyboard tray 2004 can obstruct, prevent, or limit tilting of the display, thus limiting the range of available tilt angles, though this may not always be the case. Referring to FIG. 27, in the first position 2022 the riser 2006 obstructs movement of the display such that the display cannot tilt back from a vertical orientation to the same extent available in the second position. In some cases in the second position 2024 the display mount 2002 and/or display 2010 are unable to tilt forward to a vertical orientation because the keyboard tray 2004 and/or keyboard obstruct forward movement due to the closeness of the display to the keyboard tray. In some embodiments the first position/configuration has a maximum backward tilt of less than about 20 degrees back from a vertical orientation. In certain embodiments the second position and second configuration have a maximum backward tilt of at least 30 degrees back from a vertical orientation. In some cases the display mount 2002 and the display 2010 can tilt up to about 45 degrees back from a vertical orientation in the second position/configuration.

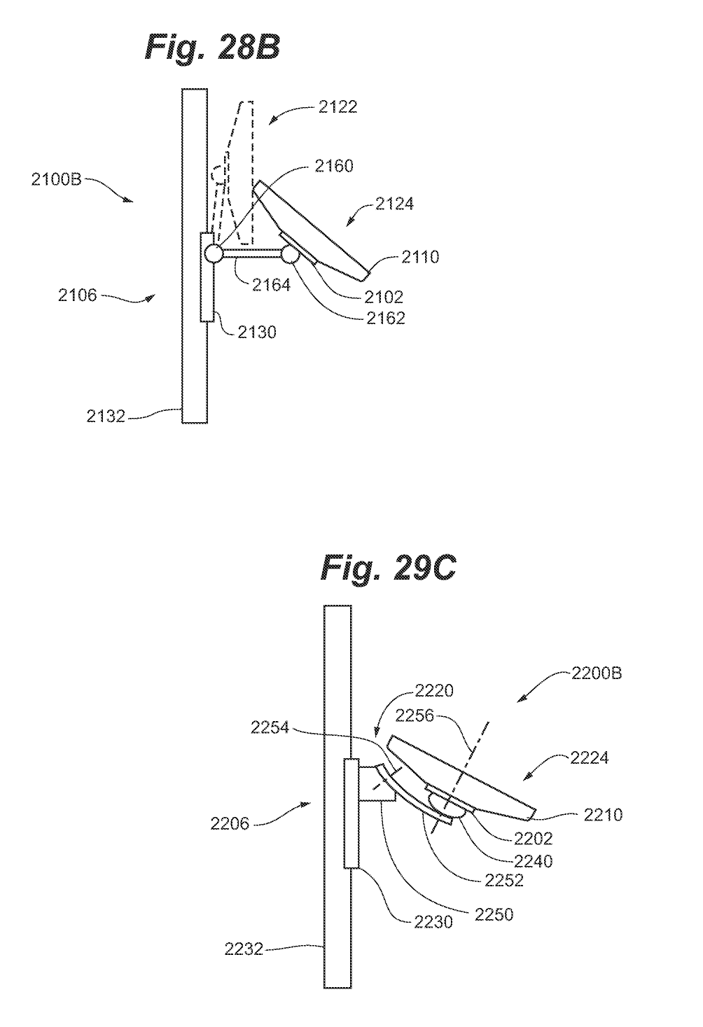

FIG. 28A is a side schematic view of a positioning apparatus 2100A in accordance with another embodiment of the invention. The positioning apparatus 2100A includes a riser 2106, a display mount 2102, a keyboard tray 2104, and a movement mechanism 2120. The movement mechanism 2120 includes pivot or tilt mechanisms 2160, 2162 and a folding arm 2164 that couples the display mount 2102 and an attached display 2110 to a riser bracket 2130 of the riser 2006. The pivoting arm provides the display mount 2102 with at least a first position 2122 (shown with the display illustrated in phantom) relative to the riser in a first, generally horizontal viewing configuration. The arm also provides the display mount 2102 with at least a second position 2124 relative to the riser 2106 in a second, generally declining viewing configuration. As described above with reference to FIG. 27, the movement mechanism 2120 shown in FIG. 28A also provides a useful mechanism for adjusting the tilt and viewing angle of the display 2110 between the generally horizontal viewing configuration and the generally declining viewing configuration. Movement of the display 2110 from the first position 2122 to the second position 2124 enables an operator to view the display 2110 in a generally declining orientation, which can be useful for operators wearing bifocal lenses as described above.

The pivoting arm 2164 pushes the display mount 2102 from the first position 2122 forward, away from the riser, and downward to the second position 2124, in close proximity with the keyboard tray 2104. According to certain embodiments, the pivoting arm 2164 does not include a counter balance mechanism and relies on a brake or lock for holding the display mount and display in the first or second viewing positions 2122, 2124. In certain embodiments, the range of tilt angles and orientations of the display 2110 available in each of the first and second positions are similar to those described above with respect to FIG. 27.

FIG. 28B is a side schematic view of another version of a positioning apparatus 2100B in accordance with an embodiment of the invention. In this embodiment, the positioning apparatus 2100B is configured to support an electronic display, but does not include a keyboard tray as in the embodiment shown in FIG. 28A. Accordingly, for applications in which use of a keyboard is not necessary or not desirable, the apparatus 2100B in FIG. 28B can be useful for positioning a display without the cost and space needed to implement a keyboard tray. In particular, the embodiment in FIG. 28A can be useful for positioning a touch screen computer, such as a tablet computer. For example, the movement mechanism 2120 shown in FIG. 28B can be used to adjust the tilt and viewing angle of the display 2110 between a generally horizontal viewing configuration and a generally declining viewing configuration as discussed above. Accordingly a user can view an electronic display such as a tablet computer from a variety of angles, including a generally declining orientation, which can be useful for operators wearing bifocal lenses as described above. Unless otherwise stated, it is contemplated that each of the positioning apparatuses described herein as including a keyboard tray can also be implemented without a keyboard tray as with the apparatus 2100B.

One example of a contemplated use for the positioning apparatus 2100B includes transforming a traditional, stationary computer workstation into a multi-position (e.g., multi-height) computer workstation. As the use of tablet style computers increases, the positioning apparatus 2100B can be used to implement a multi-height workstation (such as a sit-to-stand workstation) that allows for viewing a tablet computer or another touch-sensitive screen from multiple angles without the need for a keyboard tray or other unnecessary structural components. Accordingly, workstations using an apparatus such as the positioning apparatus 2100B can be set up in areas with a limited amount of space. Further, while other types of equipment, such as multi-segment and multi joint positioning arms, may provide several degrees of manipulation (e.g., tilt, height adjustment, etc.), the physical structure of such arms require a large amount of space or clearance in order to provide the desired adjustments. In contrast, the inventors have designed an apparatus 21 OOB that provides a wide range of viewing angles (such as the generally-horizontal viewing orientation and the generally-declining viewing orientation described above) while occupying a small footprint by using the support column 2132 to provide height adjustment.

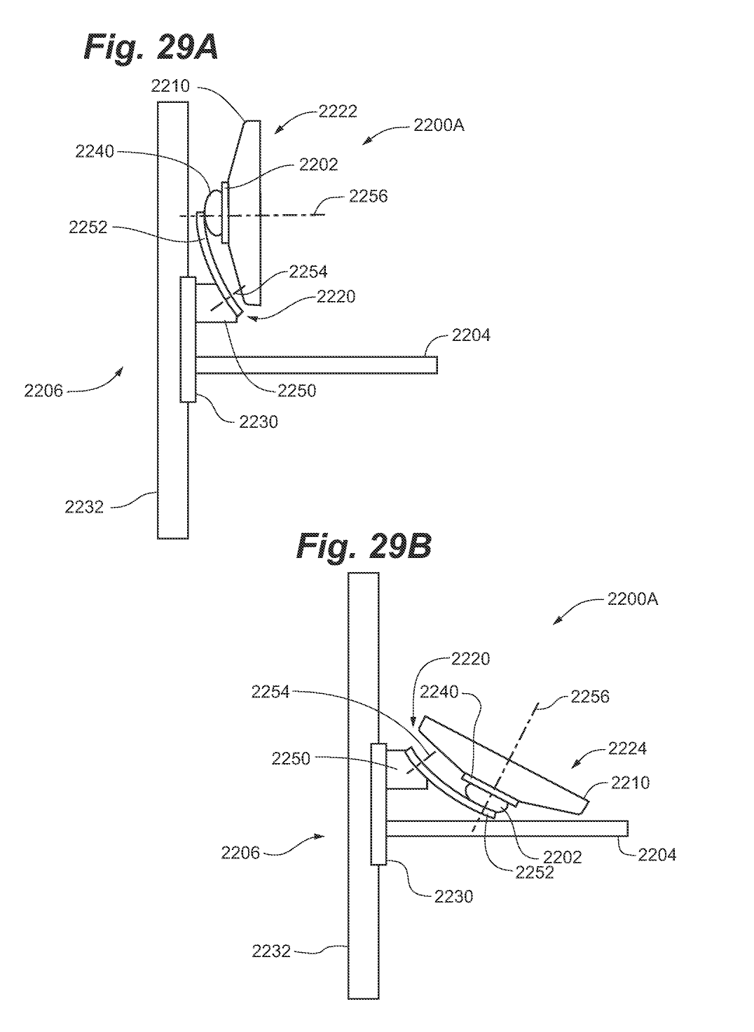

FIGS. 29A-29B are side schematic views of a positioning apparatus 2200A in accordance with another embodiment of the invention. The positioning apparatus 2200A includes a riser 2206 having a support column 2232 and a bracket 2230, a display mount 2202, a keyboard tray 2204, and a movement mechanism 2220. FIG. 29C is a side schematic view of a similar positioning apparatus 2200B that provides similar functionality but without a keyboard tray. The movement mechanism 2220 includes a panning mechanism that couples the display mount 2202 and an attached display 2210 to the riser bracket 2230. The panning mechanism provides the display mount 2202 with at least a first position 2222 relative to the riser (shown in FIG. 29A) and a second position 2224 relative to the riser 2206 (shown in FIG. 29B). As described above with reference to FIG. 27, the movement mechanism 2220 shown in FIGS. 29A-29B also provides a useful mechanism for adjusting the tilt and viewing angle of the display 2210 between a generally horizontal viewing configuration corresponding to the first position 2222 and a generally declining viewing configuration corresponding to the second position 2224. Movement of the display 2210 from the first position 2222 to the second position 2224 enables an operator to view the display 2210 in the generally declining configuration, which can be useful for operators wearing bifocal lenses as described above.

The movement mechanism 2220 includes a mount portion 2250 attached to the riser bracket 2230. An arm 2252 is rotatably coupled to the mount portion 2250 at one end and rotatably coupled to the display mount 2202 at the other end. In some cases an optional tilt mechanism 2240 can provide an additional measure of tilt adjustment at any given position. As an operator moves the display 2210 between the first and the second positions 2222, 2224, the arm 2252 rotates with respect to the mount portion 2250 about a first rotation axis 2254. The display mount 2202 and the display 2210 sweep through a circular path toward the second position 2224, in close proximity with the keyboard tray 2204. The arm 2252 rotates about 180 degrees between the first position and the second position. In some cases the display mount 2202 and the display also rotate with respect to the arm 2252 about a second rotation axis 2256 as the arm is rotated, thus allowing the display to remain in an upright viewing direction. In some embodiments the range of tilt angles and orientations of the display 2210 available in each of the first and second positions are similar to those described above with respect to FIG. 27.

The positioning apparatus 2200B in FIG. 29C provides similar functionality to the apparatus 2200A in FIGS. 29A-29B, but does so without a keyboard tray, analogous to the apparatus 2100B illustrated in FIG. 28B.

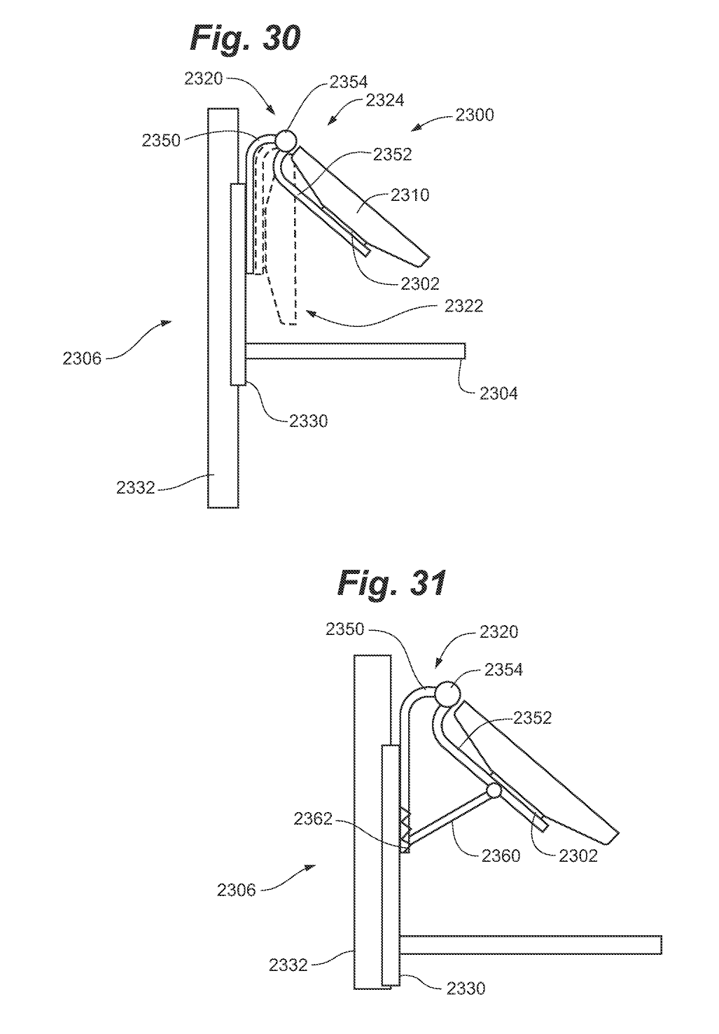

FIG. 30 is a side schematic view of a positioning apparatus 2300 in accordance with another embodiment of the invention. The positioning apparatus 2300 includes a riser 2306 having a support column 2332 and a bracket 2330, a display mount 2302, a keyboard tray 2304, and a movement mechanism 2320. The movement mechanism 2320 includes a mounting bracket 2350 attached to the riser bracket 2330 and an arm 2352 coupled to the display mount 2302. A pivot mechanism 2354 is attached at the end of the mounting bracket 2350 between the mounting bracket 2350 and the arm 2352, allowing the arm 2352 and the attached display mount 2302 and display 2310 to pivot away from the riser 2306. The movement mechanism 2320 provides the display mount 2302 with at least a first position 2322 (shown with the display illustrated in phantom) relative to the riser in a first viewing configuration and a second position 2324 relative to the riser 2306 in a second viewing configuration.

As described above with reference to FIG. 27, the movement mechanism 2320 shown in FIG. 30 also provides a useful mechanism for adjusting the tilt and viewing angle of the display 2310 between a generally horizontal viewing configuration (i.e., with the display mount in the first position 2322) and a generally declining viewing configuration (i.e., with the display mount 2002 in the second position 2324). In this embodiment movement between the first position 2322 and the second position 2324 swings the display mount 2302 out and up relative to the riser 2306 to tilt the supported display 2310 back from a vertical orientation. The second position 2324 is thus located at a greater horizontal distance from the riser 2306 than the first position 2322 and also at higher vertical position relative to the riser than the first position 2322.

Although not required, in some cases additional relative movement between the display mount 2302 and the keyboard tray 2304 can ensure that the keyboard is positioned relatively closely to the display in the generally declining viewing configuration. For example, in certain embodiments the apparatus may include a separate keyboard riser (not shown) that couples the keyboard tray 2304 to the riser 2306. Thus, as the movement mechanism 2320 moves the display mount 2302 out and up to position the display 2310 in the second position, the keyboard riser can also be adjusted to move the keyboard tray 2304 up toward the display mount 2302 to provide the second viewing configuration. In some embodiments the keyboard riser may provide about 5 inches of vertical adjustment, though other amounts are also contemplated.

In some embodiments the movement mechanism 2320 may alternatively or additionally include an additional riser (not shown). For example, a display riser positioned between the display mount 2302 and the arm 2352 can allow the display mount 2302 and the display 2310 to be moved closer to the keyboard tray 2304 in the second, generally declining viewing configuration. In certain embodiments a display riser (not shown) may alternatively or additionally be provided between the riser bracket 2330 and the mounting bracket 2350. Such a separate display riser can allow the display mount 2302 and the display 2310 (along with the pivot mechanism 2354) to be moved downward, closer to the keyboard tray 2304 while in the second position 2324 to provide the second viewing configuration.

As shown in FIG. 30, in certain cases the mounting bracket 2350 is curved at one end and positions the pivot mechanism 2354 above the display mount 2302 and the display 2310. Such a configuration allows the display 2310 to be positioned closely adjacent to the riser 2306 in the first position 2322, while also allowing the display to tilt back and up into the generally declining orientation without obstruction from the riser 2306. In certain cases the pivot mechanism 2354 is preferably counterbalanced, although this is not required. For example, the pivot mechanism 2354 may include a counterbalanced spring system (e.g., a torsion spring mechanism), a gravity tilt mechanism, a friction tilt mechanism, or a ball and socket mechanism, among other possibilities. U.S. Pat. No. 6,997,422, filed Aug. 20, 2003; U.S. Pat. No. 7,252,277, filed Jan. 17, 2004; and US Patent Application Publication US 2006/0185563 A1, filed Sep. 28, 2005, provide examples of possible tilt and rotation mechanisms, the entire disclosure of each of which is hereby incorporated herein by reference.

In certain embodiments a supporting mechanism may support the display mount 2302 and the attached display 2310 in the second position 2324 in addition to or instead of a counterbalanced tilt mechanism. FIG. 31 illustrates one embodiment including a lever 2360 that rotatably couples to the movable arm 2352 and can be used to support and/or lock the arm 2352 in the second position 2324. The lever 2360 engages notches 2362 or another similar structure located on the mounting bracket 2350. In some cases, the attached display can generate a significant amount of torque on the pivot mechanism 2354 and the lever 2360 can be useful for reducing wobble or sagging of the movement mechanism 2320.

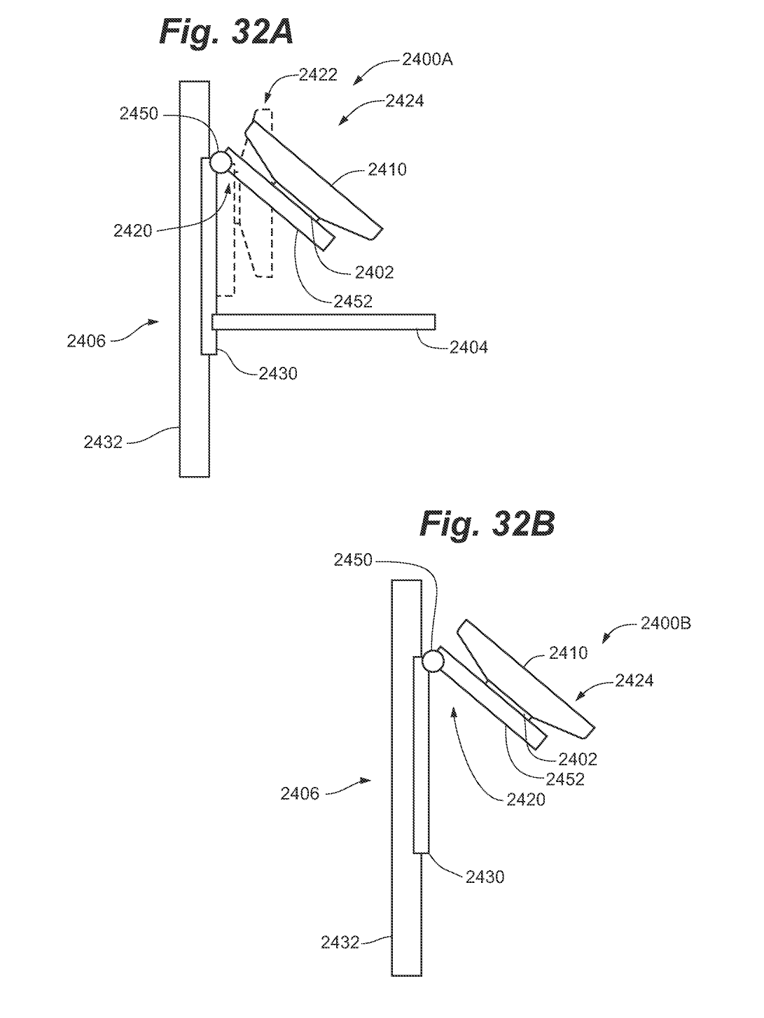

FIG. 32A is a side schematic view of a positioning apparatus 2400A in accordance with another embodiment of the invention. The positioning apparatus 2400A includes a riser 2406 having a support column 2432 and a bracket 2430, a display mount 2402, a keyboard tray 2404, and a movement mechanism 2420. The movement mechanism 2420 includes a pivot mechanism 2450 attached to the riser bracket 2430 and an arm 2452 that couples the display mount 2402 to the riser bracket 2430 through the pivot mechanism 2450, allowing the arm 2452 and the attached display mount 2402 and an attached display 2410 to pivot away from the riser 2406. The movement mechanism 2420 thus provides the display mount 2402 with at least a first position 2422 (shown with the display illustrated in phantom) relative to the riser in a first configuration and a second position 2424 relative to the riser 2406 in a second configuration.

As described above with reference to FIG. 27, the movement mechanism 2420 shown in FIG. 32A also provides a useful mechanism for adjusting the tilt and viewing angle of the display 2410 between a generally horizontal viewing configuration (with the display mount in the first position 2422) and a generally declining viewing configuration (with the display mount in the second position 2424). In this embodiment the second position 2424 is located at a greater horizontal distance from the riser 2406 than the first position 2422 and also at higher vertical position relative to the riser than the first position 2422. Movement of the display 2410 from the first position 2422 to the second position 2424 enables an operator to view the display 2410 in the generally declining viewing configuration.

In this embodiment, the arm 2452 provides the display mount 2402 and the display 2410 with independent sliding adjustment. For example, the arm 2452 may be an independent riser and/or lift mechanism (e.g., providing 5 inches or any other suitable amount of adjustment) adapted to slide the display 2410 along the length of the arm 2452. The sliding adjustment is useful for moving the display mount 2402 down the length of the arm 2452 as the arm is rotated from the first position 2422 to the second position 2424. The translation of the display mount along the length of the arm prevents the top portion of the display 2410 from hitting the riser 2406 as the display is tilted back and up. Thus, the display mount and display can be positioned closely adjacent to the riser 2406, providing the positioning apparatus with a smaller profile in the first configuration. In addition, the independent riser also provides relative movement between the display mount 2402 and the keyboard tray 2404 to ensure that the keyboard is positioned relatively closely to the display in the generally declining viewing configuration.

In certain cases the pivot mechanism 2450 is preferably counterbalanced, although this is not required. For example, the pivot mechanism 2450 may include any of the counterbalancing mechanisms described above with respect to FIGS. 30 and 31. In certain embodiments a supporting mechanism such as the lever 2360 shown in FIG. 31 may support the display mount 2402 and the attached display 2410 in the second position 2424 in addition to or instead of a counterbalanced tilt mechanism.

FIG. 32B is a side schematic view of a positioning apparatus 2400B in accordance with an embodiment of the invention. The apparatus 2400B provides similar functionality to the apparatus 2400A in FIG. 32A, but does so without a keyboard tray, analogous to the apparatus 2100B illustrated in FIG. 28B.

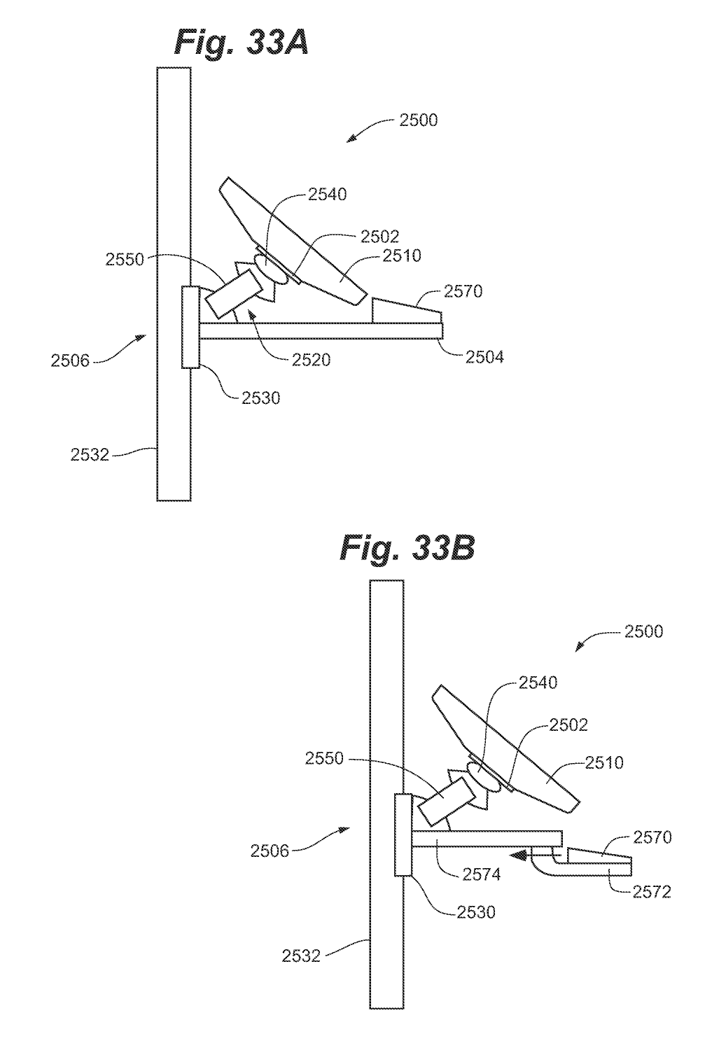

FIGS. 33A and 33B are side schematic views of a positioning apparatus 2500 in accordance with certain embodiments of the invention. In these embodiments the movement mechanism 2520 comprises a pivoting arm 2550 that moves the display mount 2502 and the attached display 2510 from a first position in a generally horizontal viewing configuration to a second position with a generally declining viewing configuration. Movement of the display 2510 from the first position to the second position enables an operator to view the display 2510 in a generally declining orientation, which can be useful for operators wearing bifocal lenses as described above. In some cases an optional tilt mechanism 2540 can provide an additional measure of tilt adjustment at any given position.

In certain embodiments the pivoting arm 2550 is a two-bar arm or a four-bar arm that tilts the display mount 2502 and the attached display 2510 as the arm is moved. US Patent Application Publication US 2007/0259554, filed May 4, 2007, the entire disclosure of each of which is hereby incorporated herein by reference, provides examples of possible arms that may be useful in embodiments of the invention. As the arm 2550 lowers into the second position, the arm 2550 tilts the display mount and display back and up, such that the display 2510 continues to be oriented toward an operator viewing the display. As the arm 2550 raises into the first position, the arm 2550 tilts the display mount and display forward and down, such that the display 2510 assumes a more vertical orientation. In certain embodiments, the range of tilt angles and orientations of the display 2510 available in each of the first and second positions are similar to those described above with respect to FIG. 27. In addition, the arm 2550 can optionally include a lift mechanism and/or counter balance mechanism to assist an operator in moving the arm between the first and the second positions.

The positioning apparatus 2500 also includes a keyboard tray coupled to the riser bracket 2530 below the display mount 2502. As shown in FIG. 33A, the keyboard tray 2504 is a flat work surface (e.g., a desk top or table) that extends out from the riser to position a keyboard 2570 in front and below the display 2510. Turning to FIG. 33B, in some cases the positioning apparatus 2500 (or any of the positioning apparatuses discussed herein) includes a dedicated keyboard tray 2572. For example, in some cases the keyboard tray 2572 is a sliding keyboard tray attached under a work surface 2574. Such adjustability can provide increased comfort for an operator by positioning the keyboard tray 2572 (and the keyboard 2570 supported on the tray) at an optimum distance from and more ergonomic relationship to the position of the attached electronic display 2510. A number of mechanisms can be used to provide horizontal adjustability, including for example, drawer slides. Although not shown, it is also contemplated that other types of keyboard trays can be used and the invention is not limited in this regard.

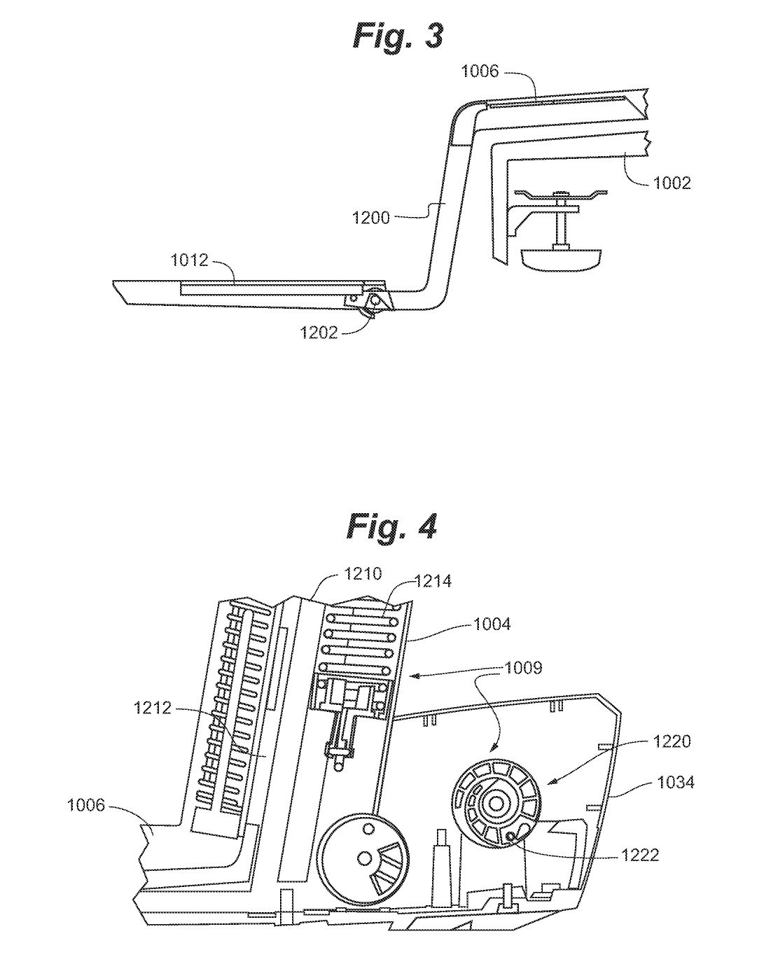

In addition, the keyboard tray 2504 illustrated in FIG. 33A, the keyboard tray 2572 illustrated in FIG. 33B, or any other useful keyboard tray may be coupled to the riser bracket 2530 with a tilt mechanism (e.g., as shown in FIG. 3) that allows an operator to adjust the tilt of the keyboard tray relative to the display 2510. In some embodiments the equipment mount also or alternatively includes a folding mechanism that allows the keyboard tray to be folded closer to the support column 2532. A folding mechanism can thus allow an operator to reduce the overall size of the positioning apparatus by folding the keyboard tray away when not in use. In some embodiments the tilt mechanism includes a hinge with a generally horizontal axis. Such a hinge may be provided with a friction mechanism.

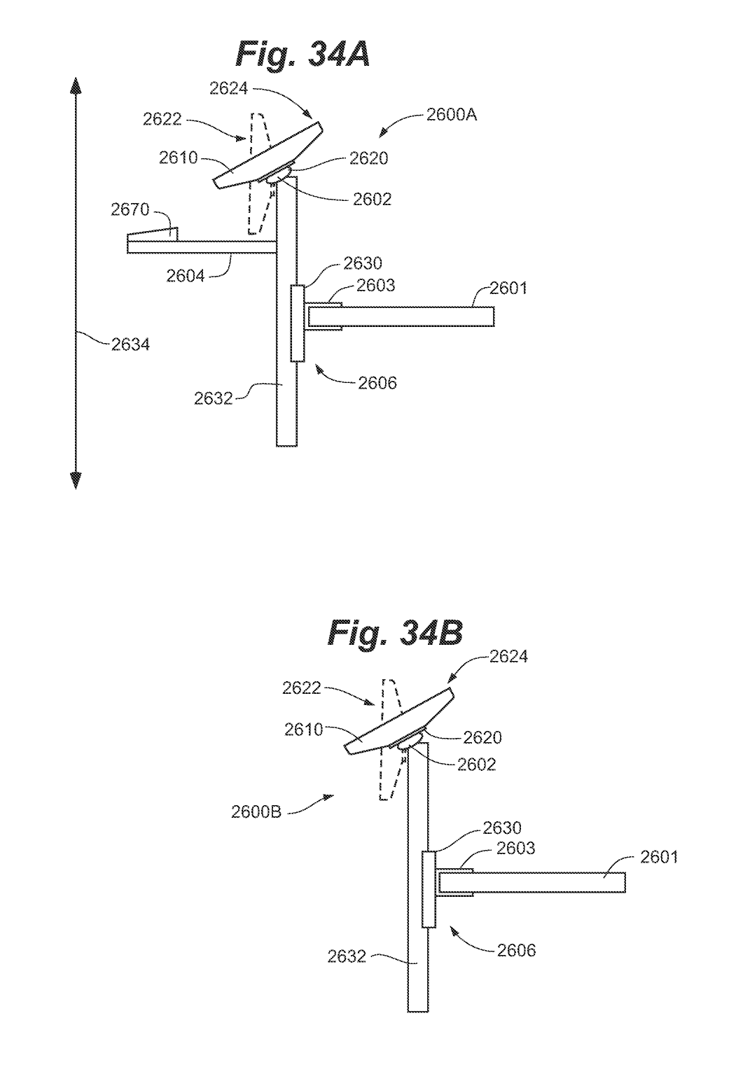

FIG. 34A is a side schematic view of a positioning apparatus 2600A attached to a support member 2601 in accordance with another embodiment of the invention. The positioning apparatus 2600 includes a riser 2606 having a riser bracket 2630 and a support column 2632, a keyboard tray 2604, a display mount 2602, and a movement mechanism 2620. In this embodiment, the movement mechanism 2620 includes a tilt mechanism that tilts the display mount 2602 and a supported display 2610 down and forward to a first position 2622 in a first generally horizontal viewing configuration and back and upward to a second position 2624 in a second, generally declining viewing configuration. The tilt mechanism 2620 is attached to a top end of the riser support column 2632, thus allowing the display 2610 to tilt backward without being obstructed by the support column 2632. For example, in some embodiments the tilt mechanism 2620 may provide a maximum backward tilt of at least 30 degrees.

Although not required, in some cases additional relative movement between the display mount 2602 and the keyboard tray 2604 can ensure that the keyboard is positioned relatively closely to the display in the generally declining viewing configuration. For example, in certain embodiments the apparatus 2600A may include a separate keyboard riser (not shown) coupling the keyboard tray 2604 to the riser 2606. Thus, as the movement mechanism 2620 tilts the display mount 2602 back and up to position the display 2610 in the second position 2624, the keyboard riser can also be adjusted to move the keyboard tray 2604 up toward the display mount 2602 to provide the second viewing configuration. In some embodiments the keyboard riser may provide about 5 inches of vertical adjustment, though other amounts are also contemplated.

The positioning apparatus 2600A provides a vertical range of travel 2634 similar to previously described embodiments of the invention. However, in this embodiment the riser bracket 2630 is mounted to the support member 2601 and the support column 2632 supports the display 2610 and keyboard 2670 through the vertical range of travel 2634 relative to the support member 2601. The positioning apparatus includes an attachment member 2603 that attaches the riser bracket 2630 to the support member 2601. In some cases the attachment member 2603 may removably fasten the bracket to the support member (e.g., a clamp), while in other embodiments, a more permanent or fixed fastener is used (e.g., bolts, screws, adhesive, etc.).

While several embodiments of the invention are described herein as including a riser that is attached to and/or supported by a support member by a riser bracket or a support column, it is contemplated that any particular embodiment can take either configuration. Thus, the positioning apparatuses described with respect to FIGS. 27-33B could alternatively have a configuration similar to that shown in FIG. 34A in which the movement mechanism, display mount, and keyboard tray are coupled to the support column, which moves relative to the bracket to provide height adjustment relative to a support member.

FIG. 34B is a side schematic view of a positioning apparatus 2600B in accordance with another embodiment of the invention. The apparatus 2600B provides similar functionality to the apparatus 2600A in FIG. 34A, but does so without the need for a keyboard tray, analogous to the apparatus 2100B illustrated in FIG. 28B.

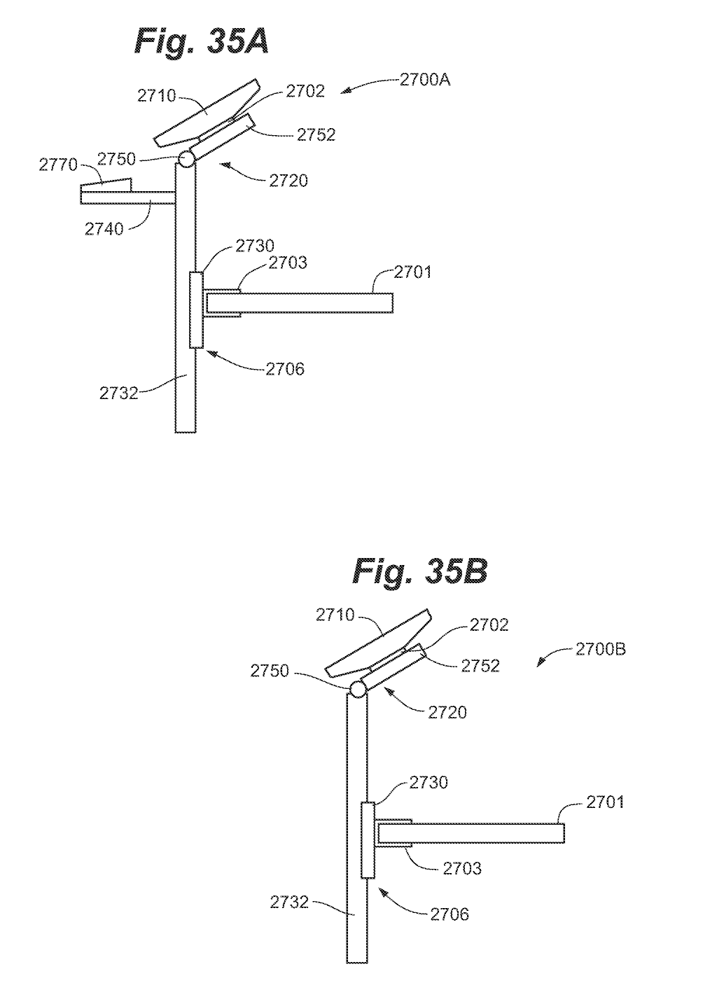

FIG. 35A is a side schematic view of a positioning apparatus 2700A in accordance with another embodiment of the invention. The positioning apparatus 2700A is similar in many respects to the positioning apparatus 2600A shown in FIG. 34A. The apparatus 2700A includes a riser 2706 with a riser bracket 2730 attached to a support member 2701, and a support column 2732 supporting a display 2710 and a keyboard tray 2704/keyboard 2770. At a top end of the support column 2732, a movement mechanism 2720 including a pivoting display riser couples the display mount 2702 and display 2710 to the support column 2732. The movement mechanism includes an inline tilt mechanism 2750 and an independent riser 2752 that can be used to tilt the display from a first position in which the display mount 2702 and the display are in a generally horizontal viewing configuration, to a second position in which the display mount 2702 and the display 2710 are in a generally declining viewing configuration 2724 shown in FIG. 35A. As the display mount 2702 is tilted back and up, the display 2710 can be moved down toward the support column by the lift mechanism 2752 to decrease the vertical distance between the display and the keyboard 2770.

FIG. 35B is a side schematic view of a positioning apparatus 2700B in accordance with another embodiment of the invention. The apparatus 2700B provides similar functionality to the apparatus 2700A in FIG. 35A, but does so without the need for a keyboard tray, analogous to the apparatus 2100B illustrated in FIG. 28B.

FIG. 36 is a side schematic view of a positioning apparatus 2800 in accordance with another embodiment of the invention. The positioning apparatus 2800 is similar to the positioning apparatus 2000 described with respect to FIG. 27. In addition, the positioning apparatus 2800 includes a telescoping riser 2806 that is configured to provide the display 2810 and a keyboard tray 2804 with vertical adjustability relative to a support member and operator.

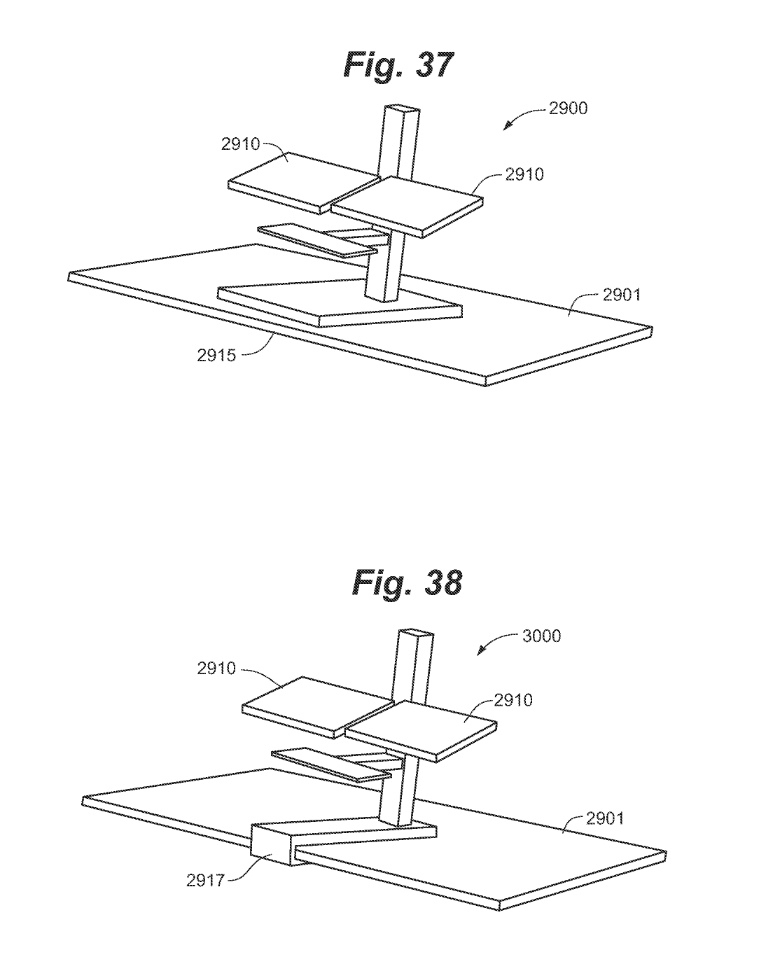

The telescoping riser 2806 generally includes a first member that is slidingly received within a second member. As illustrated, the telescoping riser 2806 includes a support column 2832 and a bracket 2830 configured to receive the support column 2832 in a sliding engagement. The telescoping riser 2806 can be attached to or rested upon a support member via an attachment member (e.g., see FIGS. 34-35) or a base (e.g., see FIG. 37). The support column 2832 and the bracket 2830 are movably coupled through a generally vertical range of travel 2834 relative to the support member and operator. In addition, although FIG. 36 illustrates the incorporation of a movement mechanism having a curved rail similar to FIG. 27, a similar telescoping configuration can be applied to each of the embodiments described herein.

In some cases rollers, slides, and optionally a lift mechanism (e.g., any of those discussed herein) are provided to movably couple the support column 2832 and the bracket 2830. In this embodiment the bracket 2830 is configured to support the display and keyboard tray. In some embodiments the orientation of the riser 2806 may be rotated 180 degrees with the bracket 2830 supported by to the support member and the support column 2632 moving relative to the support member.

FIG. 37 is a perspective view of a positioning apparatus 2900 in accordance with another embodiment of the invention. The positioning apparatus 2900 includes a movement mechanism (not shown), such as any one of those described above, for moving two displays 2910 from a first generally horizontal viewing configuration to a second generally declining viewing configuration shown in FIG. 37. In the depicted embodiment, the two displays 2910 are attached to a bow or crossbar (also not shown), which is in turn coupled to the riser with a movement mechanism for tilting the bow and thus the displays 2910. A base 2915 is attached to the riser and supports the apparatus upon a support member 2901. FIG. 38 illustrates a similar embodiment 3000, which instead of a base includes an attachment member 2917 for removably or fixedly attaching/clamping the apparatus about an edge of the support member 2901.

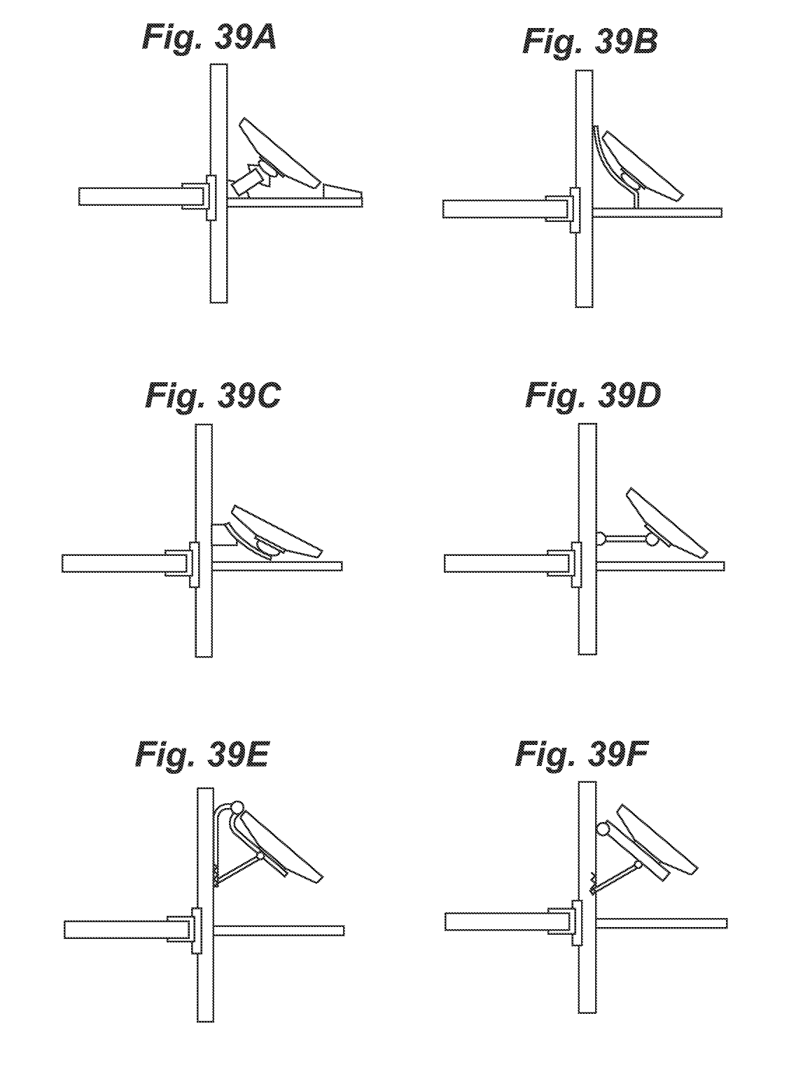

FIGS. 39A-39F are side schematic views of positioning apparatuses in accordance with additional embodiments of the invention. As discussed above, in some cases a riser configuration similar to that shown in FIGS. 34 and 35 can be adapted and used with any contemplated movement mechanism useful for moving and tilting a display as contemplated herein. FIGS. 39A-39F illustrate the use of a support column that moves through a vertical range of travel relative to a riser bracket and support member to support different examples of movement mechanisms.

Embodiments of the invention also provide methods for positioning an electronic display and/or keyboard. According to one embodiment a method for positioning an electronic display is provided. The method includes supporting an electronic display with a positioning apparatus, such as any of the positioning apparatus described above. Supporting the electronic display includes supporting the electronic display with a display mount from such an apparatus. The method also includes simultaneously moving the electronic display and the movement mechanism between a sitting position and a standing position relative to the support member and adjusting the display mount between the first configuration and the second configuration.

According to another embodiment, a method for positioning an electronic display and a keyboard includes providing a positioning apparatus with a riser having a bracket and a support column movably coupled together, a display mount coupled to the riser, a keyboard tray coupled to the riser, and a movement mechanism coupled between the riser and the display mount. The method also includes supporting the positioning apparatus with the riser in a generally vertical orientation, supporting the electronic display with the display mount, and supporting the keyboard with the keyboard tray. Further steps in the method include moving one of the support column and the bracket to simultaneously adjust the height of the display mount, display, keyboard tray, keyboard, and movement mechanism between a sitting position and a standing position, and at each of the sitting position and the standing position, configuring the display mount and the keyboard tray in a first configuration providing a generally horizontal viewing configuration and a second configuration providing a generally declining viewing configuration. In certain embodiments the vertical distance between the display mount and the keyboard tray is less in the second configuration than in the first configuration. In addition, the movement mechanism provides the display mount with a first position relative to the riser in the first configuration and a second position relative to the riser in the second configuration. In the second position the display mount and the display can tilt back from a vertical orientation to a greater degree than in the first position.

Another embodiment of the invention includes a method for positioning an electronic display and a keyboard. The method includes providing a positioning apparatus, such as one of those described herein. Additional steps include supporting the electronic display with the display mount and supporting the keyboard with the keyboard tray. The method also includes simultaneously moving the electronic display, the keyboard, and the movement mechanism between a sitting position and a standing position relative to the support member. The method also includes adjusting the display mount and the keyboard tray between a first configuration and a second configuration. In the first configuration the display mount and the display are positioned in a generally horizontal viewing orientation. In the second configuration the display mount and the display are positioned in a generally declining viewing configuration. In some cases the first configuration allows the electronic display to tilt back from a vertical orientation to a lesser degree than the second configuration.

An example of a positioning apparatus incorporating a lift/balance mechanism, an attachment member, and several other features will now be discussed with respect to FIGS. 1A-13B.

FIG. 1A is a side view of one example of a positioning apparatus 1000. FIG. 1B is a side cross-section of the positioning apparatus 1000. The positioning apparatus 1000 includes a base 1002 and a support column 1004 extending upward from the base 1002. A mounting portion 1006 is movably coupled to the support column 1004 through a generally vertical range of travel 1008, allowing the mounting portion 1006 to move up and down relative to the base 1002 and the support column 1004. For example, in some cases a lift mechanism 1009 is provided that movably couples the mounting portion 1006 and the support column 1004. The mounting portion or frame 1006 is adapted to support multiple pieces of equipment and in some cases is referred to as a common mounting frame. The mounting portion 1006 is adapted to support equipment such as an electronic display and a keyboard and move them through the vertical range of travel 1008. In the example shown in FIGS. 1A and 1B, the mounting portion 1006 includes an electronic display mount 1010 adapted to couple to and support an electronic display. In addition, the mounting portion 1006 includes a keyboard tray 1012 for supporting a keyboard.

The positioning apparatus 1000 is advantageously adapted to sit on a wide variety of existing work surfaces such as the top surfaces of desks, tables, trays, counters, and the like. One example of a contemplated use includes transforming a traditional, stationary computer workstation into a multi-position (e.g., multi-height) computer workstation.

The base 1002 of the positioning apparatus 1000 is adapted to sit on a horizontal or generally horizontal work surface. In some cases the base 1002 may also be adapted to sit on a somewhat angled or inclined work surface. In the illustrated example, the base 1002 includes a clamp 1020 for removably attaching the positioning apparatus 1000 about an edge of a work surface. The base may also or instead be fixedly attached to the work surface with a more permanent type of fastener such as an adhesive and/or a screw/bolt and mounting hole. It is also contemplated that the base and positioning apparatus may in some cases be adapted to simply sit/rest upon the work surface without being attached to the work surface.

The mounting portion 1006 illustrated in FIGS. 1A and 1B includes a frame to which the electronic display mount 1010 and the keyboard tray 1012 are attached. The frame may be formed in a variety of shapes. According to a preferred embodiment, the frame is configured to support the display mount 1010 and the keyboard tray 1012 in a spaced relationship, with the keyboard tray 1012 set apart from the display mount 1010 in order to allow an operator to comfortably use a keyboard on the tray while viewing a display mounted to the mount. For example, the keyboard tray 1012 may be attached to the frame at a generally lower and more forward position (closer to the operator) than the display mount 1010.

The display mount 1010 is attached to the mounting portion 1006 in an adjustable manner. The mounting portion 1006 includes a secondary lift mechanism 1022 to which the display mount is attached. The secondary lift mechanism 1022 provides an adjustable range of travel that allows the display mount 1010 (and an attached electronic display) to be moved vertically relative to the keyboard tray 1012, which can be useful for providing monitor/keyboard arrangements for differently sized operators. The display mount 1010 attachment may also include a tilt and/or rotation mechanism that allows an attached display to be tilted and/or rotated in a variety of directions.

The base 1002 of the positioning apparatus 1000 can encompass any structure that adequately supports the support column 1004 and the mounting portion 1006 upon a work surface. According to some embodiments, the base 1002 includes one or more stabilizing portions or legs 1030. As shown in FIGS. 1A and 1B, the base 1002 includes a first end and a second end with an elongated section 1032 extending between the first and the second ends. The portions of the elongated section 1032 are formed with a low profile, thus minimizing any obstruction caused by the base and maximizing the range of travel of the mounting portion 1006. For example, in some cases a front portion of the base 1002 in front of the support column 1004 has a thickness of about 1 inch or less. In addition, the base 1002 can also include a housing portion 1034 that houses some or all of the apparatus' lift mechanism 1009.

In some cases the elongated section 1032 of the base is generally parallel to a plane defined by movement of the mounting portion 1006 through the vertical range of travel (e.g., the plane of cross-section in FIG. 1B). In such cases the base may be adapted to be attached (e.g., removably coupled) to the work surface at the first and/or second ends of the base in front of and/or behind the support column, respectively, from the perspective of an operator. Such a configuration can advantageously reduce the footprint of the base 1002 upon the work surface, thus leaving more room for other activities as well as reducing the visual impact of the positioning apparatus. In some cases the base 1002 includes a clamp 1020 at the first end of the base that allows the base 1002 to be attached about a front edge of the work surface. Although not shown, a clamp may be provided at the second (e.g., back) end of the base 1002, allowing the base to be attached about a back edge of a work surface. In addition, the base may in some cases be configured to attach to one or more sides of a work surface through, for example, clamps located at the side of the base. In addition, the elongated section 1032 of the base may be oriented in a direction perpendicular or otherwise angled to the plane including vertical movement of the mounting portion.

The support column 1004 includes a separate component that is attached to the base 1002 using, e.g., mounting brackets or other hardware. The support column 1004 can be formed integrally with the base 1002. The support column and the base 1002 are attached/formed together at an angle other than 90 degrees (in some cases 90 degrees or less). For example, as shown in FIGS. 1A and 1B, the support column 1004 extends upward from the base 1002 at an obtuse angle 1040 with respect to the base 1002 (and a work surface positioned below the base). The obtuse angle 1040 is useful for positioning the center of gravity of the display and/or other equipment carried by the positioning apparatus at a desired position with respect to the base 1002 to enhance stability. A range of angles may be used depending upon the design and intended use for a particular embodiment. In some cases the obtuse angle 1040 is equal to or less than about 120 degrees. In some cases, the obtuse angle 1040 is equal to or less than about 100 degrees.

The support column 1004 can be dimensioned to provide the positioning apparatus with a vertical range of travel 1008 of any desired length, thus allowing the mounting portion 1006 to be moved through a wide range of heights. As will be appreciated, in cases where the support column 1004 is positioned at an angle with respect to the base, the apparatus may also provide an amount of horizontal movement as the mounting portion moves through the vertical range of travel 1008. In one example, the vertical range of travel extends between a sitting height and a standing height, thus allowing an operator to use the workstation from both a sitting position and a standing position. For example, in certain embodiments the vertical range of travel is at least about 14 inches. In some cases the vertical range of travel is between about 14 inches and about 24 inches. The lift mechanism 1009 in the positioning apparatus may also provide multiple positions at intermediate heights between the lowest and highest extents of the range of travel 1008, thus accommodating other working positions and/or operators of different heights. In some cases a discrete number of intermediate positions are provided. In some cases the lift mechanism 1009 provides an infinite number of intermediate positions within the vertical range of travel 1008.

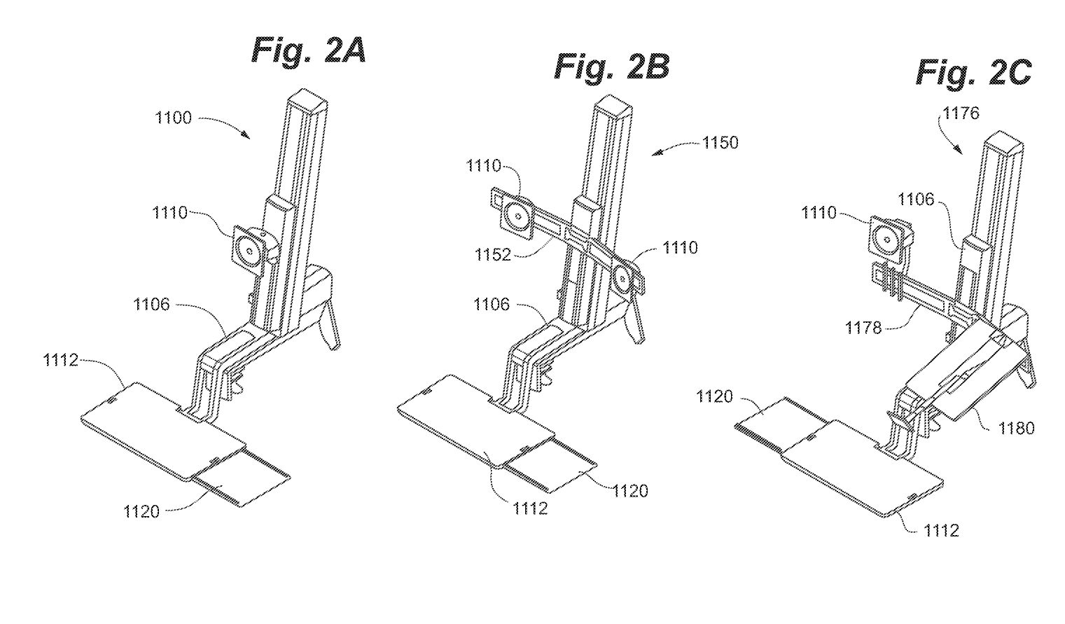

Turning to FIGS. 2A-2C, perspective views are shown of positioning apparatuses with various mounting options. Although some preferred embodiments of the invention are configured to support an electronic display and a keyboard, some positioning apparatuses can be configured with a number of optional and/or alternative mounts and supports for attaching and otherwise supporting other items. For example, in some cases the mounting portion of a positioning apparatus can include at least one of an electronic display mount, a keyboard tray, a mouse tray, a document holder, a movable work surface, and a telephone holder. In some cases a positioning apparatus includes multiple display mounts for supporting two or more electronic displays such as computer monitors. A positioning apparatus may also optionally include a notebook tray and/or a notebook docking station instead of or in addition to other mounts and supports.

FIG. 2A illustrates an example of a positioning apparatus 1100 that includes a mounting portion 1106 that has a single display mount 1110 and a keyboard tray 1112. The mounting portion 1106 also supports a mouse tray 1120 that is attached to the keyboard tray 1112. As shown in FIGS. 2B and 2C, a crossbar can also be attached to a mounting portion for attaching two or more items. FIG. 2B illustrates an example of a positioning apparatus 1150 that includes a mounting portion 1106 that has dual display mounts 1110 mounted to a crossbar 1152. The apparatus 1150 also includes a keyboard tray 1112 and a mouse tray 1120. FIG. 2C illustrates an example of a positioning apparatus 1176 that includes a mounting portion 1106 that has a single display mount 1110 and a notebook tray 1180 mounted to a crossbar 1178. The apparatus 1150 also includes a keyboard tray 1112 and a mouse tray 1120. As shown in FIGS. 2B and 2C, items can be mounted to a crossbar through various configurations, including a center mount (FIG. 2B) and/or a mount above the crossbar (FIG. 2C).

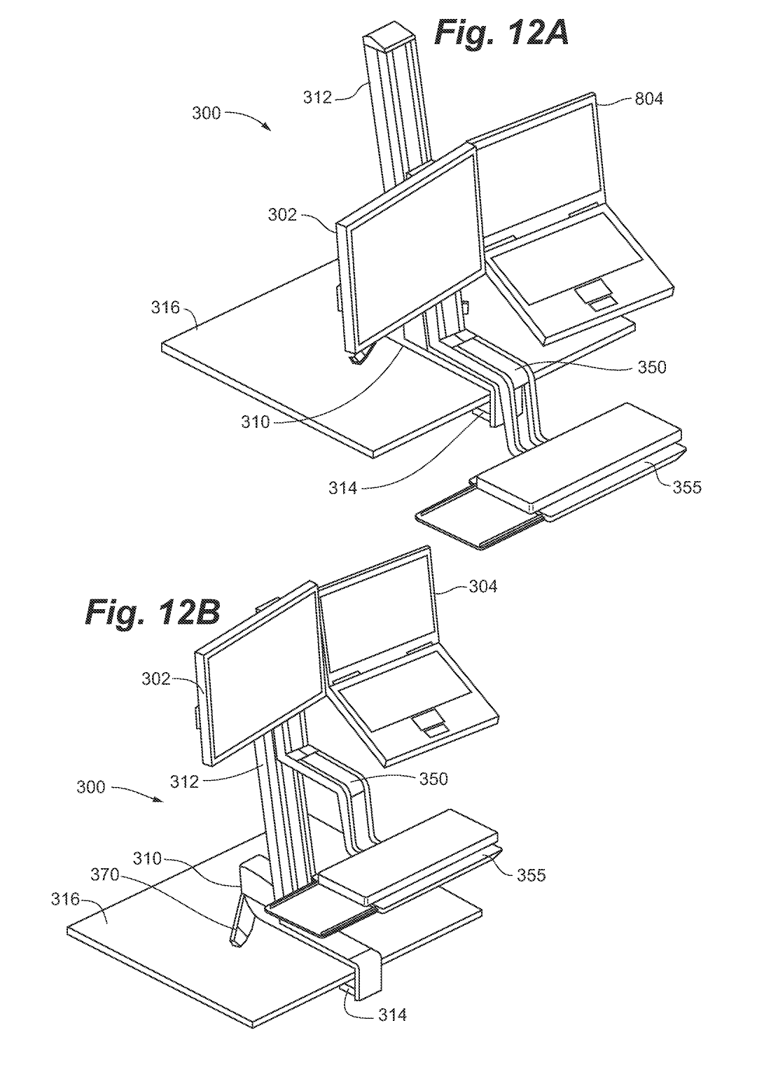

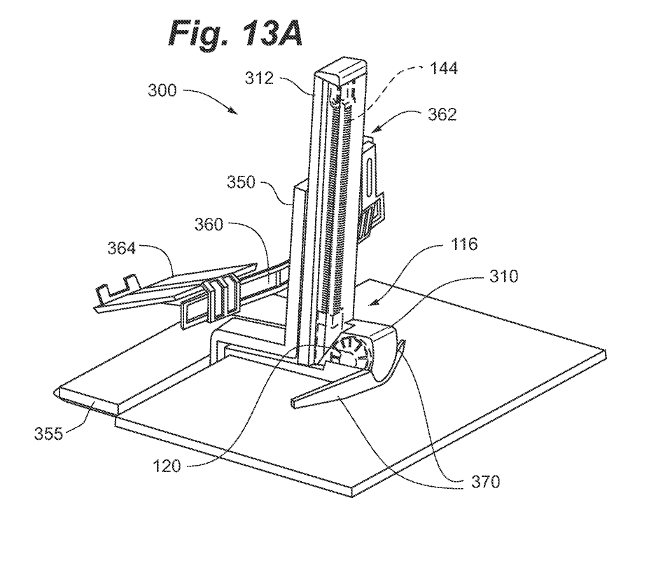

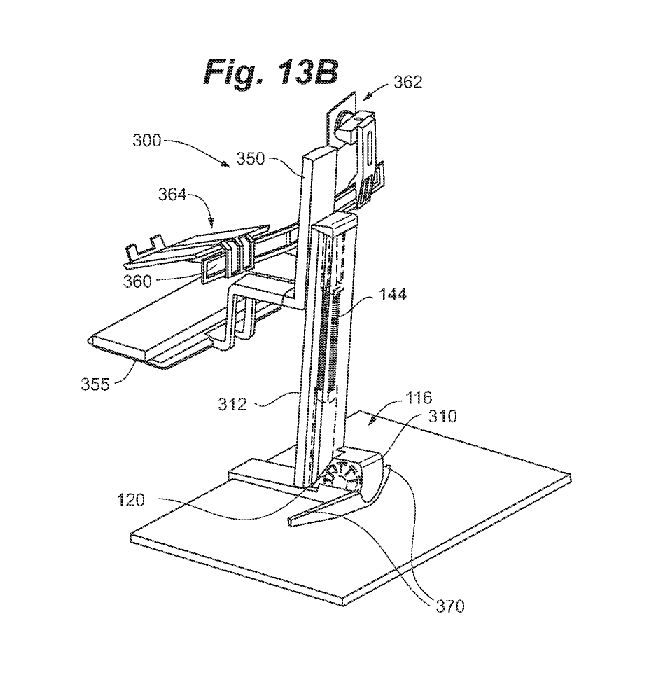

FIG. 3 is an enlarged view of the side cross-sectional view of FIG. 1B, showing details of the keyboard tray 1012. The mounting portion 1006 includes an extension arm 1200 extending downward to couple with the keyboard tray 1012. The positioning apparatus thus enables positioning of the keyboard tray 1012 below the level of the existing work surface when the mounting portion is positioned at a lower height. (See, e.g., FIGS. 12A and 13A.) Such adjustability can provide increased comfort for an operator by positioning the keyboard tray 1012 (and the keyboard supported on the tray) in a more ergonomic relationship to the position of an attached electronic display. The mounting portion extends from above the horizontal work surface to below the horizontal work surface when the tray is in a downward position. This can also obscure the base from view.

The keyboard tray 1012 is attached to the mounting portion 1006 with a tilt mechanism 1202 that allows an operator to adjust the tilt of the keyboard tray 1012 relative to the base and the work surface. For example, in some cases the tilt mechanism 1202 allows the keyboard to be oriented at an angle ranging from about −15 degrees to about +15 degrees with respect to the work surface. The mounting portion 1006 also or alternatively includes a folding mechanism that allows the keyboard tray 1012 to be folded closer to the base 1002. The folding mechanism can thus allow an operator to reduce the overall size of the positioning apparatus by folding the keyboard tray away when not in use. In some embodiments the tilt mechanism includes a hinge with a generally horizontal axis. Such a hinge may be provided with a friction mechanism.

The lift mechanism 1009 that movably couples the mounting portion 1006 to the support column 1004 includes one or more rails 1210 attached to the support column 1004 and a truck 1212 (e.g., movable bracket) having wheels or sliders that engage the rails. FIGS. 4, 5 and 6 show enlarged cross-sectional views of the lift mechanism 1009. In some cases the lift mechanism 1009 is located partially within the support column 1004 and partially within the base 1002 (e.g., within the housing portion 1034). The lift mechanism 1009 may also be located wholly within the support column 1004, attached to an external surface of the support column 1004, or otherwise mounted in a useful manner.

The lift mechanism 1009 can also provide an operator with a degree of assistance to move the mounting portion 1006 through the range of travel 1008. For example, in some embodiments an energy storage member 1214 such as an extension spring provides a biasing force that aids an operator in adjusting the height of the mounting portion 1006. In some cases an extension spring member is adjustably mounted within the support column 1004 using a retainer plug 1230 and a weight adjustment screw 1232 which can be turned to tighten and loosen the spring. The lift mechanism 1009 may provide a discrete number of height positions along the vertical range of travel, or in some cases may provide an infinite number of height positions along a continuous vertical range of adjustability.

In this case the lift mechanism 1009 includes a balance mechanism 1220 incorporating the energy storage member 1214 that can counterbalance some or all of the weight of an electronic display and/or other equipment supported by the mounting portion 1006. As just one example, the lift mechanism 1009 can incorporate a cam (e.g., a rotary cam) 1222 that is coupled to the energy storage member 1214 and the truck 1212 with one or more tension members (e.g., a line, cable, rope, chain, etc., not shown). One example of such a balance mechanism is described in presently co-owned US Patent Application Publication US 2006/0185563 A1, which application was filed Sep. 28, 2005, the entire contents of which is incorporated by reference herein. The lift mechanism 1009 includes a balance mechanism having a dual cam as described below with reference to FIGS. 14-26.

While a few examples of possible configurations for a lift mechanism are described herein, it should be appreciated that a wide variety of lift mechanisms can be used to movably couple the mounting portion 1006 with the support column 1004 to provide the vertical range of travel 1008 and that the scope of the invention is not limited to a particular lift configuration. For example, in some cases a lift mechanism has a telescoping configuration. In some cases the lift mechanism includes a rotary cam coupled with an energy storage member such as an extension spring, a compression spring, a torsion spring, or a spiral spring. In some cases the lift mechanism includes a constant force spring and/or a gas spring. The lift mechanism may also be provided as described in one or more of presently co-owned US Patent Application Publication US 2008/0026892 A1, filed Jul. 26, 2007; US Patent Application Publication US 2007/0259554 A1, filed May 4, 2007; U.S. Pat. No. 6,997,422, filed Aug. 20, 2003; U.S. Pat. No. 7,506,853, filed Nov. 3, 2004; and U.S. Pat. No. 6,994,306, filed Nov. 28, 2000. The entire disclosure of each of the above-mentioned patents and patent applications is hereby incorporated by reference herein.

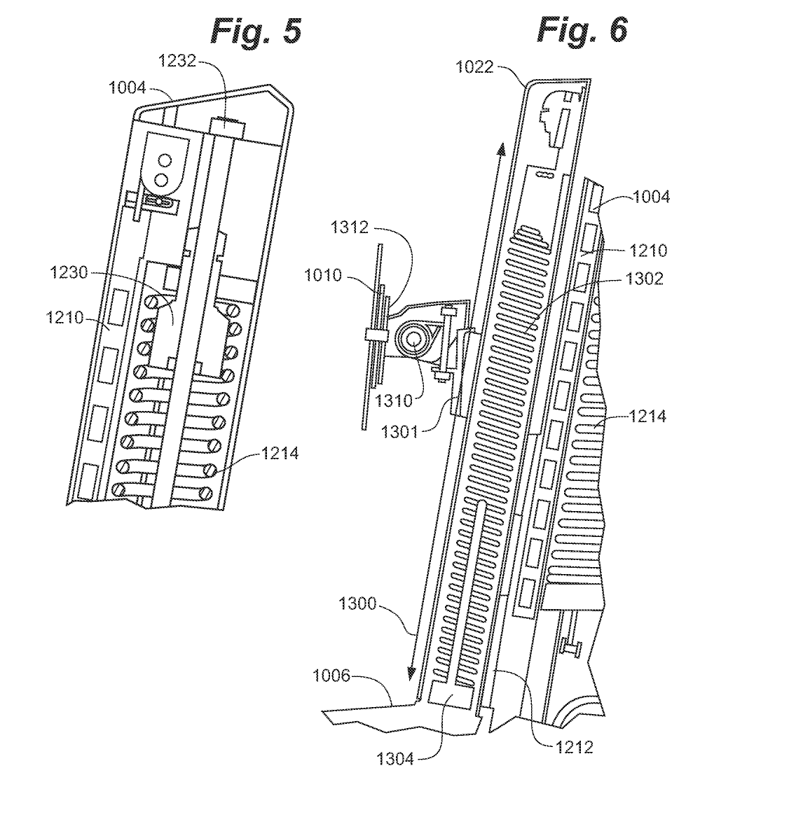

FIG. 6 includes an enlarged cross-sectional view of the secondary lift mechanism 1022 first shown in FIGS. 1A and 1B. The secondary lift mechanism 1022 provides an adjustable range of travel 1300 that allows the display mount 1010 (and an attached electronic display) to be moved vertically relative to the keyboard tray (not shown). For example, the lift mechanism 1022 may in some cases provide from about 3 inches to about 8 inches of additional vertical adjustability. The lift mechanism 1022 can comprise any suitable design, including any of the examples described immediately above with respect to the lift mechanism 1009. For example, the secondary lift mechanism 1022 may include a balance mechanism that can counterbalance some or all of the weight of the attached display through the range of travel. In some cases the secondary lift mechanism 1022 includes a truck 1301 movably coupled with one or more rails providing a second range of vertical travel for the electronic display relative to the keyboard tray. An energy storage member 1302 such as an extension spring can provide a biasing force that aids an operator in adjusting the height of the display mount 1010. In some cases the tension of the energy storage member 1302 can be adjusted with the use of a weight adjustment screw or bolt 1304. In addition, the secondary lift mechanism 1022 can coupled with the mounting portion 1006 in any suitable manner, such as being attached to an external surface of a frame of the mounting portion, or located within or partially within a columnar portion of the mounting portion 1006.

The display mount 1010 is attached to the mounting portion 1006 in one or more other adjustable manners. The display mount 1010 attachment includes a tilt mechanism 1310 and rotation mechanism 1312 that allows an attached display to be tilted and/or rotated in a variety of directions with respect to the positioning apparatus. The tilt mechanism may include a counterbalanced spring system (e.g., a torsion spring mechanism), a gravity tilt mechanism, a friction tilt mechanism, or a ball and socket mechanism, among other possibilities. U.S. Pat. No. 6,997,422, filed Aug. 20, 2003; U.S. Pat. No. 7,252,277, filed Jan. 17, 2004; and US Patent Application Publication US 2006/0185563 A1, filed Sep. 28, 2005, provide examples of possible tilt and rotation mechanisms, the entire disclosure of each of which is hereby incorporated herein by reference.

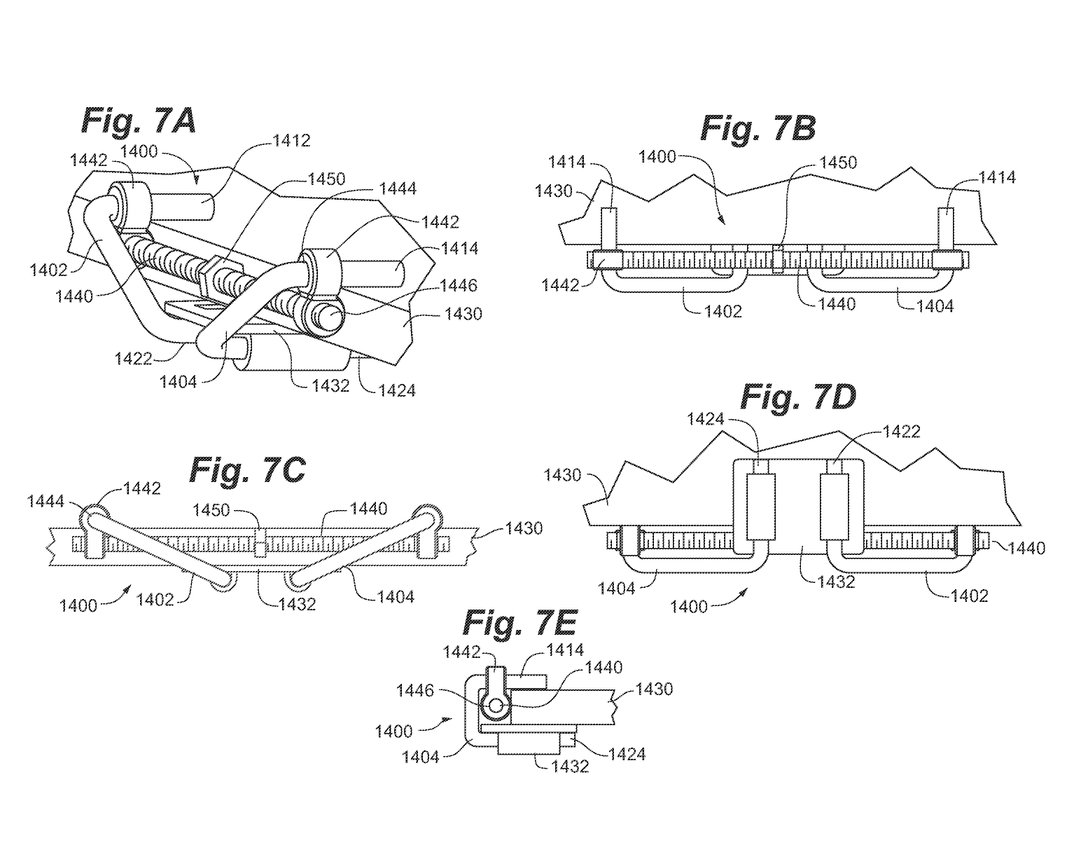

As discussed with reference to FIGS. 1A and 1B, the base 1002 of the positioning apparatus 1000 can be removably coupled to an existing work surface with the use of a clamp 1020. Many types of clamps can be used to removably couple the positioning apparatus to a work surface. FIG. 7A is a perspective view of a screw clamp 1400 that provides a clamping mechanism having several advantages over traditional clamps, including providing a low profile clamp while still accommodating work surfaces a wide range of thicknesses with the same clamp. FIGS. 7B, 7C, 7D, and 7E are top, front, bottom, and side views of the screw clamp 1400, respectively. The screw clamp 1400 includes two clamping elements 1402, 1404 (e.g., U-shaped bend wires) that include upper portions 1412, 1414 and lower portions 1422, 1424 that fit about the edge of a work surface 1430 and can be adjusted to clamp to the work surface 1430 by pressing together the bottom and top surfaces of the work surface 1430. The lower portions 1422, 1424 of the clamping elements are coupled together in a spaced relationship (e.g., with a bracket 1432) such that the upper portions 1412, 1414 are able to pivot around the fixed lower portions to clamp about the edge of the work surface 1430.

An adjustable screw 1440 is threadedly coupled to the upper portions of the first and the second clamping elements. Turning the screw 1440 loosens and tightens the clamp 1400 by pulling and pushing the upper portions of the clamping elements together and apart. A threaded insert 1442 is rotatably coupled to the upper portion of each clamping element through a slip fit hole 1444. The insert 1442 includes a threaded hole 1446, oriented perpendicular to the slip fit hole, that receives an end of the screw 1440. In some cases an adjustment nut 1450 is attached (e.g., welded or machined) to the screw 1440 to facilitate rotation of the screw 1440. Turning the nut 1450 and the screw 1440 in a first direction moves the upper portions 1412, 1414 of the clamping elements apart to decrease the space between the upper and lower portions of the clamping elements 1402, 1404 and thus tighten the clamp 1400 about the edge of the work surface 1430. Turning the nut 1450 and the screw 1440 in an opposite, second direction moves the upper portions 1412, 1414 of the clamping elements together to increase the space between the upper and lower portions of the clamping elements 1402, 1404 and thus loosen the clamp 1400 about the edge of the work surface 1430. Fixed bracket 1432 can be placed on top of a work surface and the bracket is formed as part of the base 1032.

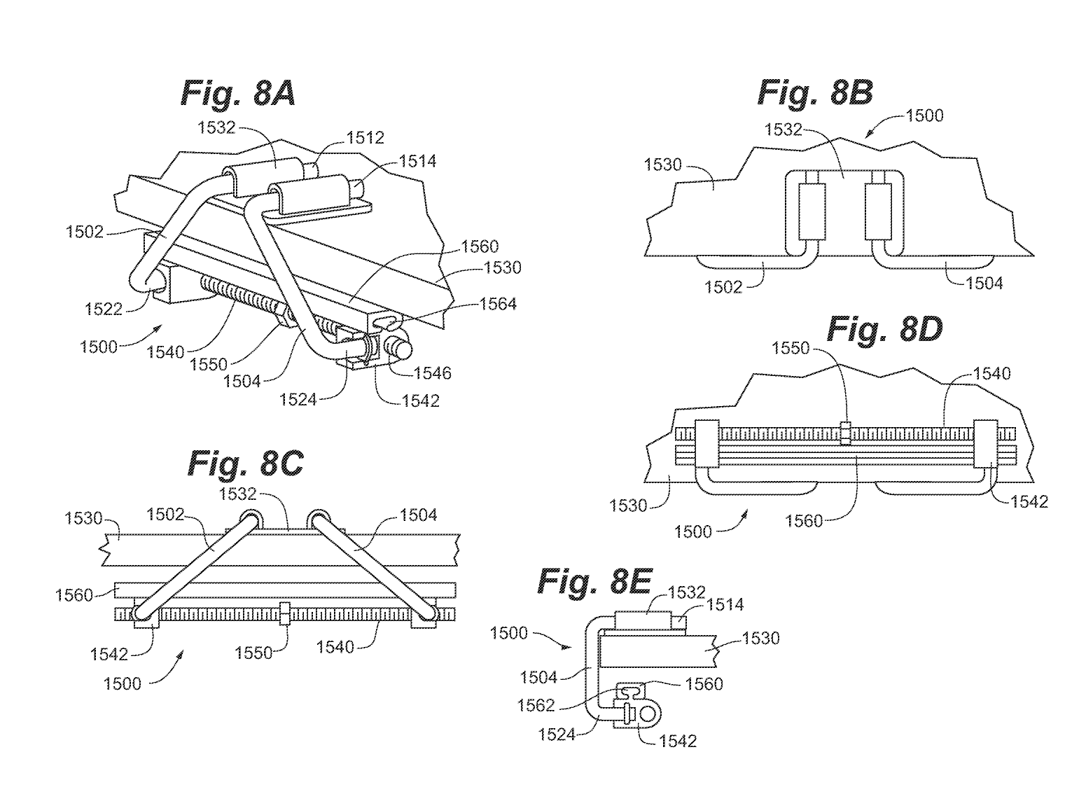

FIGS. 8A-8E are various views of another type of screw clamp 1500 that can be useful for removably coupling a positioning apparatus about the edge of a work surface. The screw clamp 1500 includes two clamping elements 1502, 1504 (e.g., U-shaped bend wires) that include upper portions 1512, 1514 and lower portions 1522, 1524 that fit about the edge of a work surface 1530 and can be adjusted to clamp to the work surface 1530. The upper portions 1512, 1514 of the clamping elements are coupled together in a spaced relationship (e.g., with a bracket 1532) such that the lower portions 1522, 1524 are able to pivot around the fixed upper portions to clamp about the edge of the work surface 1530.

An adjustable screw 1540 is threadedly coupled to the lower portions of the first and the second clamping elements. Turning the screw 1540 loosens and tightens the clamp 1500 by pulling and pushing the lower portions of the clamping elements together and apart. A threaded insert 1542 is rotatably coupled to the lower portion of each clamping element. The insert 1542 includes a threaded hole 1546, oriented perpendicular to the lower portion, that receives an end of the screw 1540. In some cases an adjustment nut 1550 is attached (e.g., welded or machined) to the screw 1540 to facilitate rotation of the screw 1540. In addition, in some cases an extrusion 1560 is slidingly mounted to the threaded inserts 1542 and provides a flat surface above the adjustable screw for engaging the bottom of the work surface. For example, each threaded insert 1542 may have a “T” shaped extension 1562 that fits within a slot 1564 of the extrusion 1560. Turning the nut 1450 and the screw 1540 in a first direction moves the lower portions 1522, 1524 of the clamping elements apart to decrease the space between the upper and lower portions of the clamping elements 1502, 1504 and thus tighten the extrusion 1560 against the bottom of the work surface 1530. Turning the nut 1550 and the screw 1540 in an opposite, second direction moves the lower portions 1522, 1524 of the clamping elements together to increase the space between the upper and lower portions of the clamping elements 1502, 1504 and thus loosen the clamp 1500 about the edge of the work surface 1530. In some cases bracket 1532 can be formed as an integral part of the base 1032.

In addition to providing a relatively low profile above the work surface 1530, the screw clamp 1500 shown in FIGS. 8A-8E also occupies a minimum area at the side of the work surface 1530 since the adjustable screw 1540 and the extrusion 1560 are positioned below the work surface 1530.

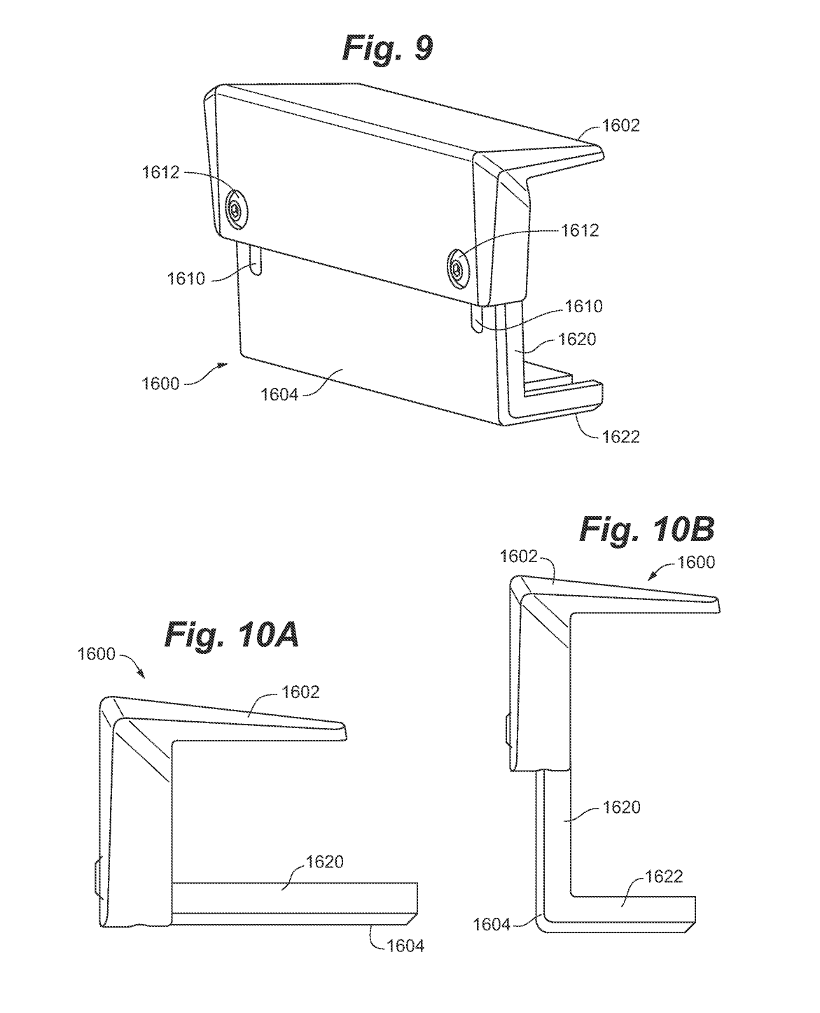

FIGS. 9-11 are various views of a C-clamp 1600 that can removably couple a positioning apparatus about the edge of a work surface according to some embodiments of the invention. The C-clamp 1600 includes an upper bracket 1602 coupled to a lower bracket 1604. In certain embodiments the upper and lower brackets each have two legs formed at a right angle, which allows the brackets to clamp about the edge of a work surface 1630 by pressing on the top surface 1632 and the bottom surfaces 1634 of the work surface 1630. In addition, the lower bracket 1604 (or alternatively the upper bracket) may include mounting slots 1610 that provide an adjustable sliding engagement with the upper bracket such that the clamp 1600 can be adjusted to attach to work surfaces of different thicknesses. For example, screws/bolts 1612 can be inserted into the slots and paired with nuts to tighten together the upper and lower brackets. In some embodiments, upper leg 1602 can be formed as part of the base 1032. In such embodiments, the base extends forward and bends downward at the edge of the work surface to form the upper leg 1602.

In certain embodiments, the lower bracket 1604 can be coupled with the upper bracket 1602 in more than one configuration in order to accommodate work surfaces with a greater range of thicknesses. Referring to FIG. 9, in some embodiments the lower bracket 1604 includes a first leg 1620 and a second leg 1622, and the length of the first leg 1620 is longer than the length of the second leg 1622. Turning to FIG. 10A, the short/second leg 1622 can be coupled with the upper bracket in some cases to clamp about work surfaces having a relatively small thickness. In certain cases the long/first leg 1620 can be coupled with the upper bracket as shown in FIG. 10B in order to clamp about work surfaces having a greater thickness. Accordingly, the C-clamp 1600 can be adjusted to attach a positioning apparatus to a wide variety of pre-existing work surfaces.

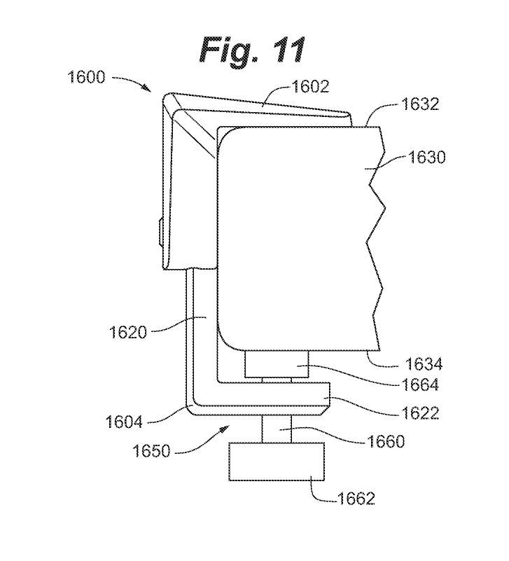

Turning to FIG. 11, in some embodiments an adjustable pressure mechanism 1650 can further enhance the operation of the C-clamp 1600 by providing a tighter clamp about an edge of the work surface 1630. For example, in some cases each of the first and the second legs of the lower bracket 1604 is adapted to threadedly receive a threaded rod 1660 of a screw knob 1662. The screw knob also includes a washer 1664 or other engaging member that presses into the bottom surface 1634 of the work surface 1630 as the screw knob 1662 is turned. According to this embodiment, it is possible to use the same C-clamp 1600 on a wide range of work surface thicknesses without using a screw knob having an extremely long threaded rod. Instead a screw knob having a shorter threaded rod can be used with additional adjustability provided by the various configurations of the upper and lower brackets 1602, 1604 and the adjustable coupling between the brackets. Accordingly, some embodiments provide a small profile clamp 1600 in which the screw knob 1662 sticks out a smaller amount when the clamp is mounted on a thinner desk surface.

FIGS. 12A-13B illustrate various views of an exemplary positioning apparatus 300 according to one embodiment of the invention. FIGS. 12A and 12B show the positioning apparatus 300 from in a lowered position and a raised position, respectively, from a front perspective. According to some embodiments of the invention, the positioning apparatus 300 is useful in applications in which a single operator may wish to both sit and stand while using the same monitor and/or notebook. For convenience, the positioning apparatus 300 can be described for such uses as a “sit-stand” positioning apparatus. Such sit-stand apparatuses can be useful in situations in which operators desire to perform operations in various postures, which may be required or desired to be performed at the same workstation. For example, one may desire to perform some operations in a seated position and other operations in a standing position. Applicants believe embodiments of the invention provide the first sit-stand positioning apparatus of its type to be compatible with an existing, independent work surface (e.g., a desk top, table top, counter top, etc.) to form a sit-stand workstation. The positioning apparatus allows an operator to use the workstation at multiple heights if desired without the need for separate work surfaces at multiple heights. Accordingly, an operator does not need to move to a different workstation, but can adjust the height of the sit-stand workstation and continue using the existing work station at the new height. Further, embodiments of the invention allow for relatively large ranges of travel while occupying a smaller footprint on a work surface where space is valuable, as will be discussed further herein.

FIGS. 13A and 13B are rear perspective views of the positioning apparatus 300 in a lowered position and a raised position, respectively. The positioning apparatus 300 supports an electronic display in the form of a computer monitor 302, in addition to a notebook computer 304 in accordance with an embodiment of the invention. The positioning apparatus 300 includes a base 310 and a generally vertical support column 312 connected to the base 310. A movable mounting portion 350 is movably coupled to the support column 312 and attaches the monitor 302 and notebook 304 to the apparatus. In some cases the mounting portion 350 may also movably couple a keyboard tray 355 to the support column 312.

Referring to FIGS. 13A and 13B, the apparatus 300 can include a crossbar 360 attached to the mounting portion 350 for mounting various equipment. For example, in some cases a monitor mount 362 (e.g., a standard VESA connector), notebook tray 364, and/or other pieces of equipment are attached to the crossbar 360, allowing the mounting portion 350 to support and move the monitor, notebook, and/or other equipment. It should be appreciated, however, that a wide variety of equipment can be moved by the mounting portion 350. For example, the mounting portion 350 could be adapted to support and move a combination of one or more monitors and/or notebooks or other equipment. In some cases, the mounting portion 350 is adapted to support and move a combination of monitors and notebooks (e.g., two monitors and a notebook, three monitors and a notebook). In some cases, the mounting portion 350 is adapted to support and move multiple monitors, such as sets of two, three, or four or more monitors. (See FIGS. 2A-2C for some examples of mounting options.)

As shown in FIGS. 12A, 12B, 13A, and 13B, the positioning apparatus 300 can provide a wide range of travel for the attached monitor and notebook. The height of the equipment (and mounting portion 350) can be set to any one of an infinite number of heights within the range of travel. FIGS. 12A and 13A illustrate positioning apparatus 300 in a low position (e.g., for sitting), while FIGS. 12B and 13B illustrate positioning apparatus 300 in a high position (e.g., for standing). To provide such adjustability for the monitor 302 and the notebook 304, the positioning apparatus 300 may in some cases include a lift mechanism similar in respects to the lift mechanism 116 described in FIGS. 14-16 herein after. FIGS. 13A and 13B illustrate lift mechanism 116 incorporated into positioning apparatus 300. As can be seen, the wheel pulley 120, as well as first and second cams 124, 126, and pulley system 130 (not shown) are positioned within the base 310. The energy storage member 144, in this case an extension spring, is positioned within the support column 312 and coupled between the support column 312 and the remaining portion of the lift mechanism.

The mounting portion 350 can itself provide some degree of adjustability between attached components. For example, as shown in FIGS. 12A, 12B, 13A, and 13B, in some cases a second lift mechanism is incorporated within or attached to the mounting portion 350 as described above with respect to FIGS. 1A and 1B. This can advantageously allow, for example, the crossbar 360 and monitor 302 and the notebook 304 to be height adjusted with respect to the keyboard tray 355 to accommodate different operators.

In the example shown in FIGS. 12A and 12B, the support column 312 is connected to the base 310 at an angle, which is useful for positioning the center of gravity of the monitor 302 and notebook 304 at a desired location with respect to the base 310 to enhance stability. In some cases, the positioning apparatus 300 is advantageously adapted to be used with an existing horizontal work surface 316, such as a desk or table. For example, base 310 may include multiple stabilizing legs 370 that hold the apparatus 300 upright on the work surface 316. In some cases base 310 includes a clamp 314 useful for securing positioning apparatus 300 to the horizontal work surface 316.

As discussed above, a positioning apparatus can include a base encompassing any structure that adequately supports the support column and the mounting portion upon a work surface. With continuing reference to FIGS. 12A-13B, the base 310 includes a first end and a second end with an elongated section extending between the first and the second ends. Portions of the elongated section are formed with a low profile, thus minimizing any obstruction caused by the base and maximizing the range of travel of the mounting portion 350. In some cases the elongated section of the base 310 is generally parallel to the mounting portion 350. In addition, in some cases the elongated section has a width approximately the same as a width of the mounting portion frame directly above the base and the support column 312. Such a configuration can advantageously reduce the footprint of the base 1002 upon the work surface, thus leaving more room for other activities as well as reducing the visual impact of the positioning apparatus. For example, the widths of the elongated section of the base, the frame of the mounting portion, and the support column 312 are equal to or less than about 5 inches. In some cases, the widths of the elongated section, the frame of the mounting portion, and the support column 312 are equal to or less than a width of an electronic display mount (e.g., a VESA mount) attached to the mounting portion.

Referring to FIGS. 12A-13B, one exemplary method for positioning an electronic display and a keyboard involves selecting an existing generally horizontal work surface 316 and providing a positioning apparatus such as the positioning apparatus 300. In some cases the positioning apparatus has a base 310 adapted to sit on the work surface 316, a support column 312 extending upward from the base 310, and a mounting portion 350 movably coupled to the support column 312 through a vertical range of travel relative to the work surface 316. The method also includes attaching the positioning apparatus 300 to the work surface 316 and supporting an electronic display 302 and a keyboard with the mounting portion 350 of the apparatus. The method also includes moving the mounting portion 350 between a sitting position (e.g., FIG. 12A) and a standing position (e.g., FIG. 12B) relative to the work surface 316.

Positioning methods also include moving the electronic display 302 simultaneously with the keyboard (e.g., on the keyboard tray 355). In addition, one exemplary method also includes moving the electronic display 302 with respect to the keyboard. An operator may also adjust an angle of the keyboard and/or the electronic display relative to the work surface 316 by, e.g., manipulating an articulating mount such as a tilt and/or rotation mechanism. Another positioning method includes attaching the positioning apparatus about one of a front edge, a back edge, and a side edge of the work surface 316.

As will be appreciated, sit-stand positioning apparatuses may be subjected to more frequent adjustment (e.g., several times in a work day) than more traditional, stationary monitor mounts. In some cases a lift mechanism is used that can increase the cycle life of the apparatus as it encounters increased articulation. Referring now to FIGS. 14-26, an example including a lift/balance mechanism 116 incorporating the use of a dual surface cam is described.

FIG. 14 is an elevation view of one example of an apparatus 100. Apparatus 100 of FIG. 14 comprises a base 102 and a generally vertical support column 106 connected to the base 102, similar to examples described above with respect to FIGS. 1-13B. The base may include any structure for supporting the apparatus. The base may include a relatively flat horizontal surface useful for placement on a horizontal work surface or may include a clamp to clamp the apparatus to a horizontal surface or a wall bracket to attach the apparatus to a vertical wall. The support can be connected to the base by any suitable method. In some cases the support is pivotably connected to the base such that the support can pivot with respect to the base. In the example shown in FIG. 14, the support is connected to the base at an angle. The angle is useful for positioning the center of gravity of the monitor or other equipment carried by the support at a desired position with respect to the base to enhance stability.

Portions of a balance mechanism 116 can also be seen in FIG. 14. As will be described in more detail herein, the portions of the balance mechanism shown in FIG. 14 include a wheel pulley 120, a first cam 124 and a second cam 126, and a pulley system 130.

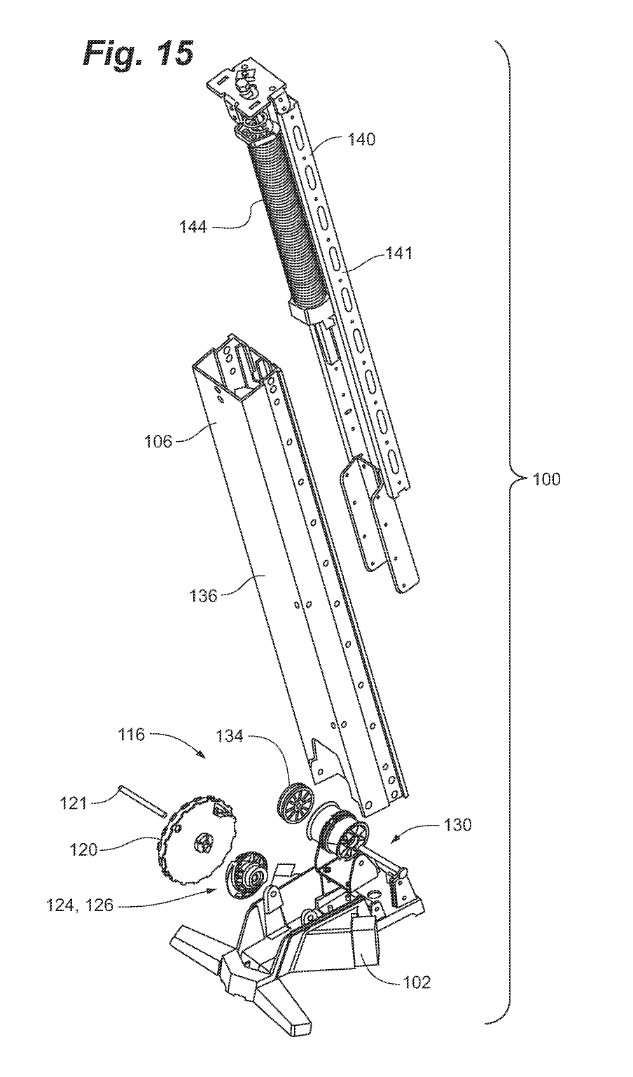

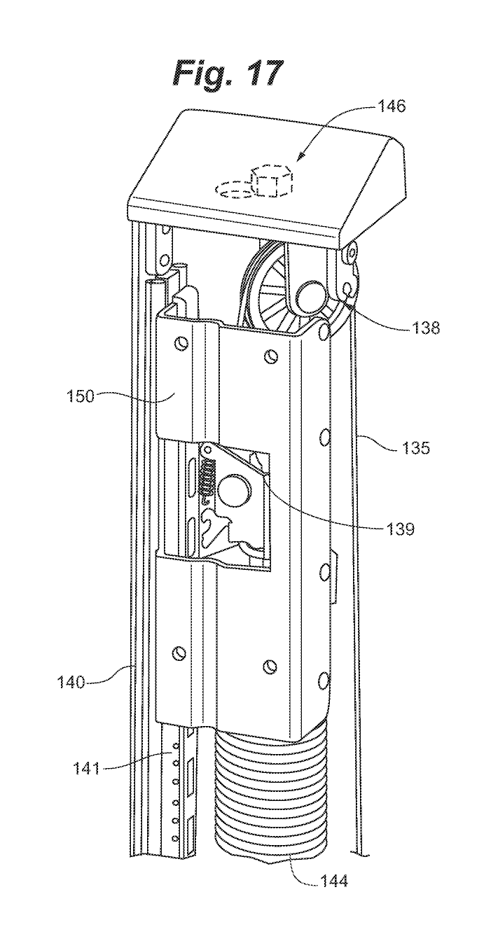

FIG. 15 is a partially exploded version of FIG. 14. In FIG. 15, it can be seen that the generally vertical support column 106 includes a first portion 136 and a second portion 140. As shown in FIG. 17, once fully assembled, a movable portion 150 (e.g., sometimes referred to as a bracket or truck) is coupled to the second portion 140. As discussed earlier herein with respect to FIGS. 28A-B, the support column 106, including the first and the second portions, and the movable portion 150 or bracket form a riser that provides a positioning apparatus with a range of adjustability. For example, movable portion 150 and second portion 140 are disposed in sliding engagement with one another such that the movable portion can translate with respect to second portion 140. The second portion 140 may include rails 141 and the movable portion 150 may include wheels that roll along the rails. In general, first portion 136 and second portion 140 are connected to base 102, and the movable portion 150 is connected to one or more monitors and/or other computing equipment that translate along with the movable portion 150 with respect to first and second portions 136, 140. For example, the movable portion 150 may be coupled to or integrally include a mounting portion as discussed above with respect to FIGS. 1A and 1B. As shown in FIG. 15, an energy storage member 144 is coupled to second portion 140. Energy storage member 144 may include any device useful for storing potential energy, such as a spring (e.g., an extension spring, compression spring, torsion spring, etc.). The energy storage member may be adjustable by an energy storage member adjustment mechanism 146 (e.g., a threaded bolt with a bracket that changes the effective at rest length of the energy storage member when actuated).

The balance mechanism 116 provides a balancing force between the first and second portions of the support column and the movable portion 150, such that an operator can position equipment attached to the movable portion at any desired height along the range of travel having only to overcome the friction of the system. Further, because of the balancing force provided by the balance mechanism, the movable portion will hold its set position without the operator having to engage any locks.

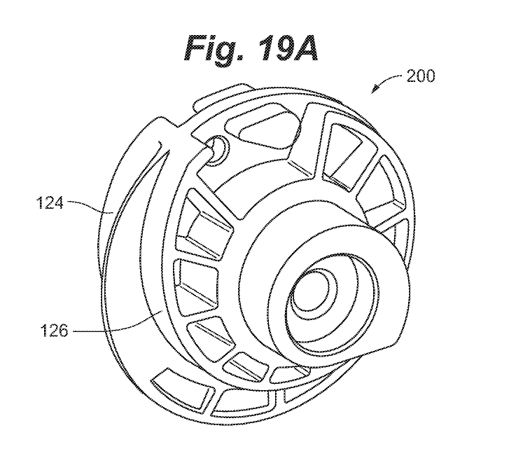

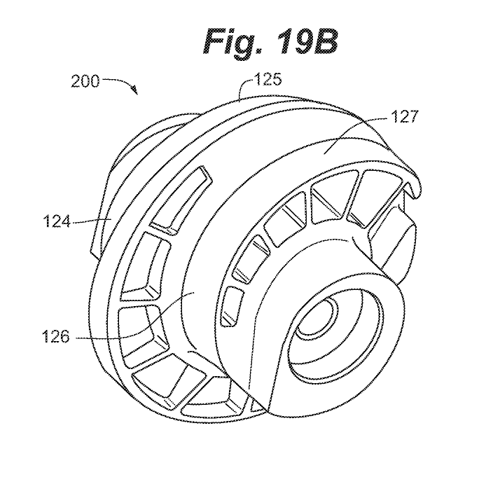

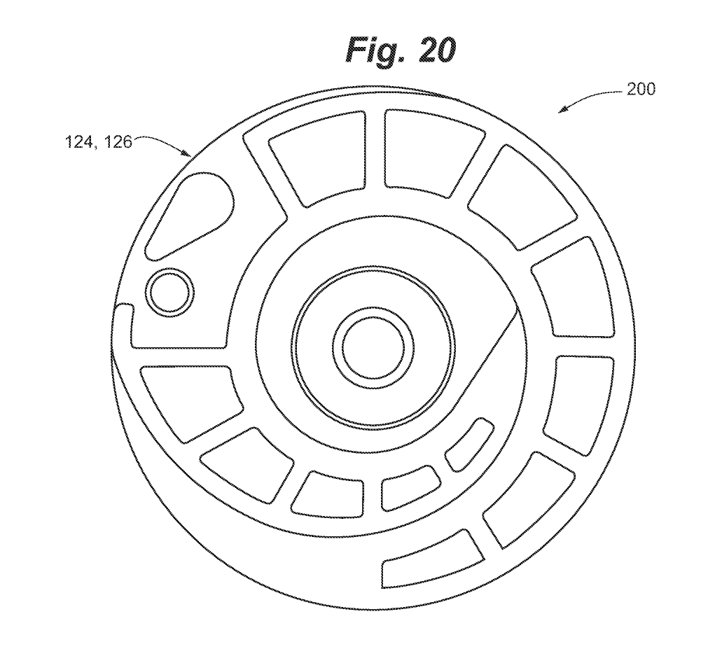

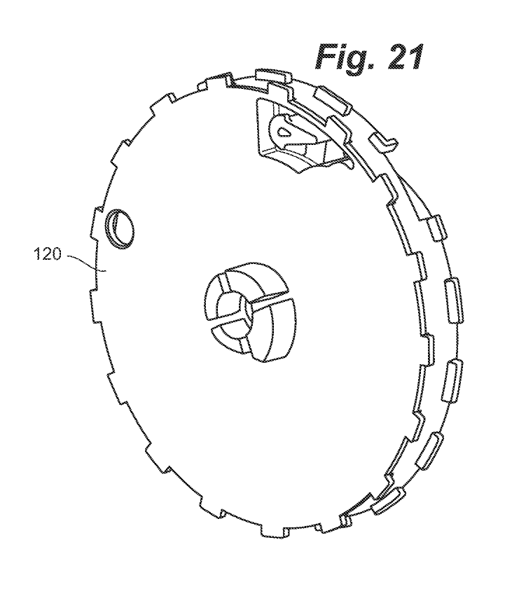

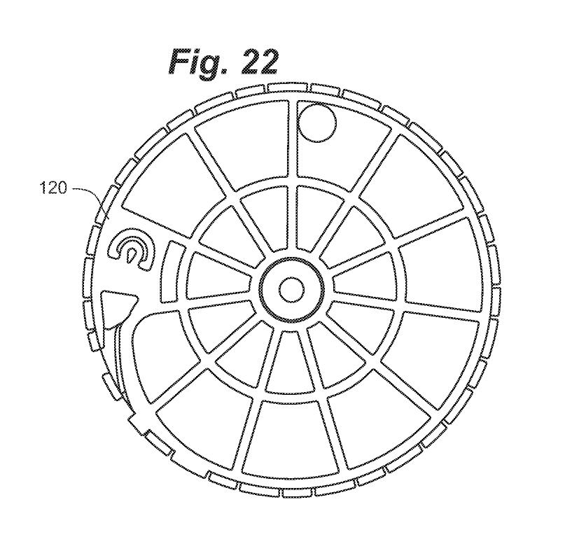

In the example shown in FIGS. 14 and 15, the wheel pulley 120 is coupled to first cam 124 and second cam 126, which rotate along with rotation of the wheel. As shown, first cam 124 and second cam 126 can be provided as a single integral cam member. In addition, the wheel pulley and cam member may be provided as different pieces connected directly together through axle 121. In another example, they may be integrally formed or separated by a distance when installed. FIGS. 19A, 19B, and 20 provide perspective and side elevation views of a cam member including both first and second cams 124, 126. FIGS. 21 and 22 provide perspective and side elevation views of wheel pulley 120.

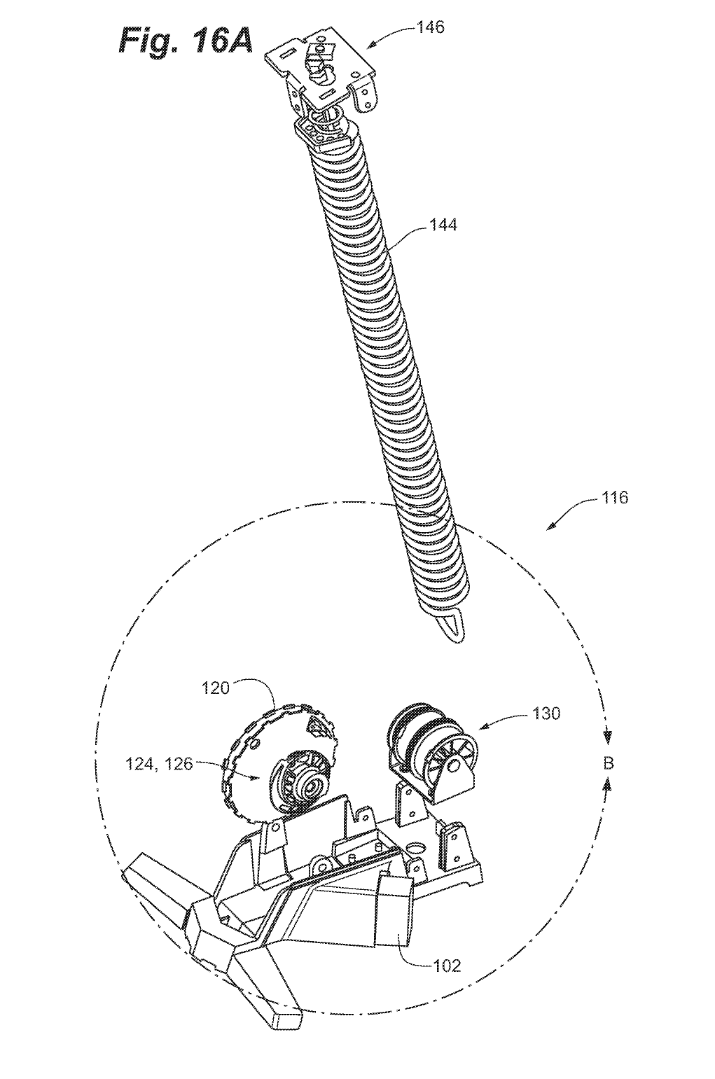

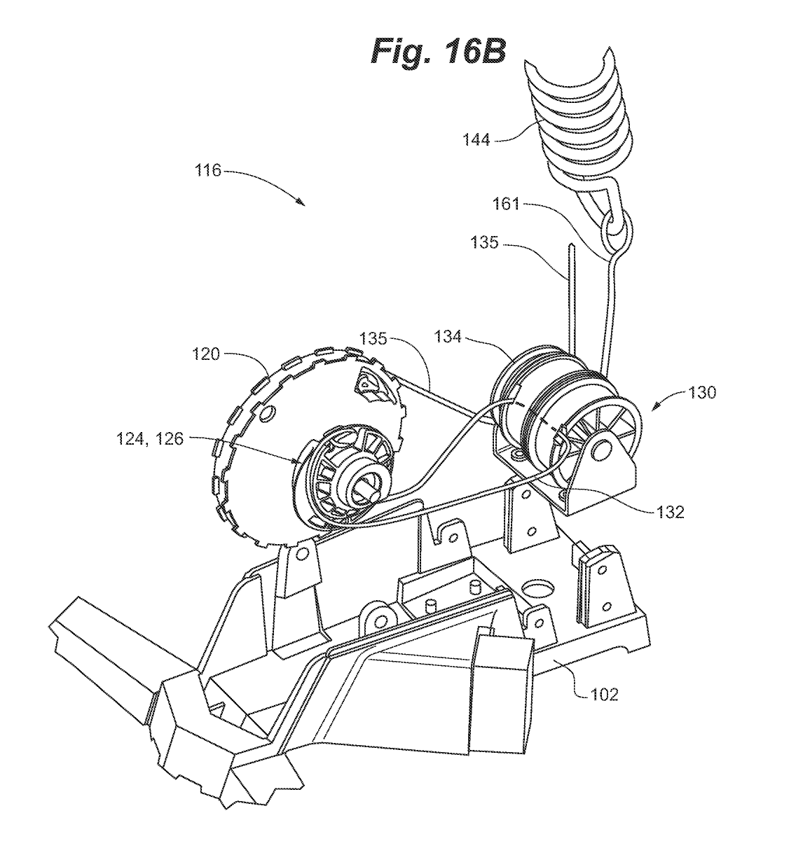

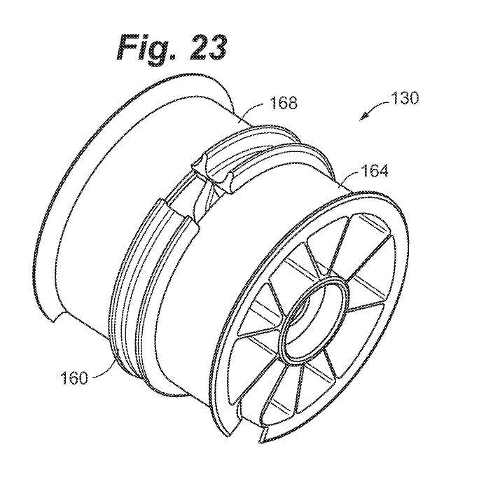

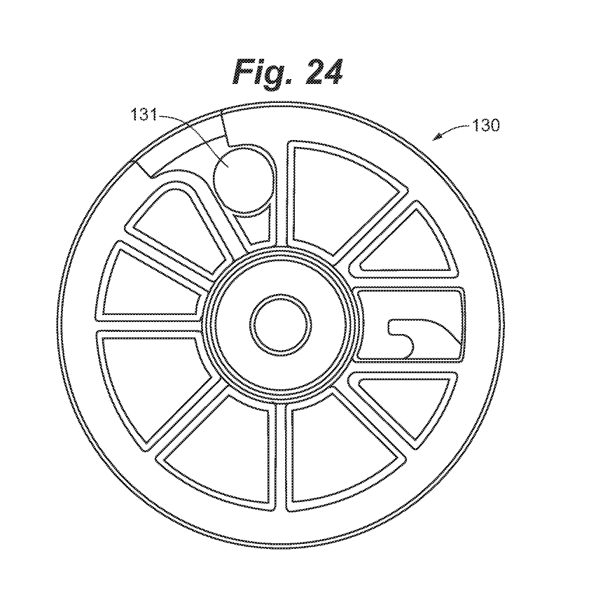

FIGS. 16A and 16B provide other perspective views of the balance mechanism 116, illustrating an arrangement of wheel pulley 120, first and second cams 124, 126, a pulley system 130, and energy storage member 144. In this case the first and second cams 124, 126 are directly coupled to the energy storage member 144 via one or more flexible elements (sometimes referred to as a tension or tensile member) that are routed around pulley system 130. The flexible element can be a rope or cable and can include any material useful for transmitting force, such as a tensile polymer. Referring to FIG. 16B, in some cases first cam 124 and second cam 126 are coupled indirectly to the energy storage member 144 via the pulley system 130. FIGS. 23 and 24 illustrate one embodiment of pulley system 130, which includes cam pulleys 164, 168, and an energy storage member pulley 160 coupled to the cam pulleys. As shown, the energy storage member pulley and the cam pulleys are provided in a single piece construction.

In some cases each of the first and second cams 124, 126 are coupled to one of the cam pulleys 164, 168 with an independent, separate flexible element, while energy storage member pulley 160 is coupled to the energy storage member 144 via a separate flexible element. Referring to FIG. 24, in some cases the pulley system 130 includes a through hole 131, through which a single flexible element 132 can be threaded and then coupled to the cams 124, 126, one at each end. Such an arrangement is illustrated in FIG. 16B. As the cams rotate and pull (or loosen) flexible element 132, the flexible element 132 engages with the cam pulleys, and is unwound from (or wound around, respectively) each of the cam pulleys.

In one case the wheel pulley 120 is coupled to the movable portion 150 of the support with another flexible element 135 such that wheel pulley 120 rotates with respect to the base 102 as the movable portion 150 moves with respect to the support. As shown in FIGS. 15 and 16B, an additional direction changing pulley 134 can direct the flexible element 135 between the wheel pulley 120 and the movable portion 150. Turning to FIG. 17, the direction of flexible element 135 is again changed by upper pulley 138 and flexible element 135 is coupled to the movable portion 150 using a hook 139 or another similar device known in the art.

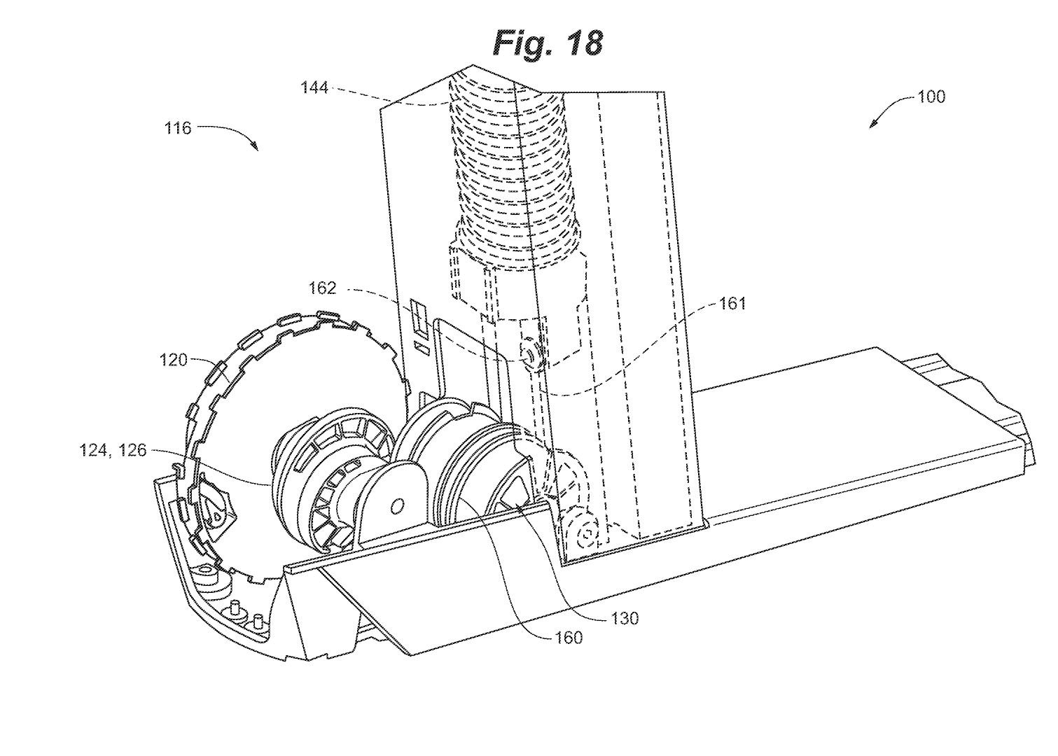

FIG. 18 is a partial perspective view of a bottom portion of the apparatus 100, depicting the balance mechanism 116. As discussed above, energy storage member pulley 160 is coupled to the energy storage member 144 via a separate flexible element 161. In some cases the energy storage member 144 includes a hook 162 that allows for easily coupling the flexible element 161 to member 144. Member 144 is positioned within support column 106 such that hook 162 is generally aligned with the outer edge of pulley system 130, and specifically with energy storage member pulley 160. In the example shown, as energy storage member pulley 160 rotates, it winds or unwinds the flexible element 161, allowing energy storage member 144 to contract and extend. Accordingly, the force or weight of movable portion 150 of the support, as well as any equipment coupled thereto, can be offset and balanced by the energy storage member, through the transmission and redirection of force through the flexible elements, pulleys, and cams to energy storage member 144.

FIGS. 19A and 19B provide perspective views, and FIG. 19C is a side view of a cam member 200 incorporating first and second cams 124, 126. As shown, first cam 124 and second cam 126 can be incorporated into the single integral cam member 200 in some cases, though this is not a requirement and the invention is not intended to be limited to this example. The first and second cams are cooperatively shaped and positioned so that a torque applied to wheel pulley 120 by a flexible element is substantially constant while a force applied to wheel 120 by the flexible element varies. For example, the effective radius of each cam 124, 126 varies as a function of the angular orientation of wheel 120. Also, the effective radius of each cam member may vary as a function of the displacement of an energy storage member of the balance mechanism. In some cases the two cams 124, 126 are mirror images of each other, and have the same profile of radius variation as a function of rotation. As shown in FIG. 6B, the cams 124, 126 each include a camming surface 125, 127 upon which the flexible elements wind. Cams 124, 126 are each designed to balance half of the weight of the movable portion 150 and any attached equipment, which can decrease stress and fatigue on the flexible elements and increase the life of the apparatus.

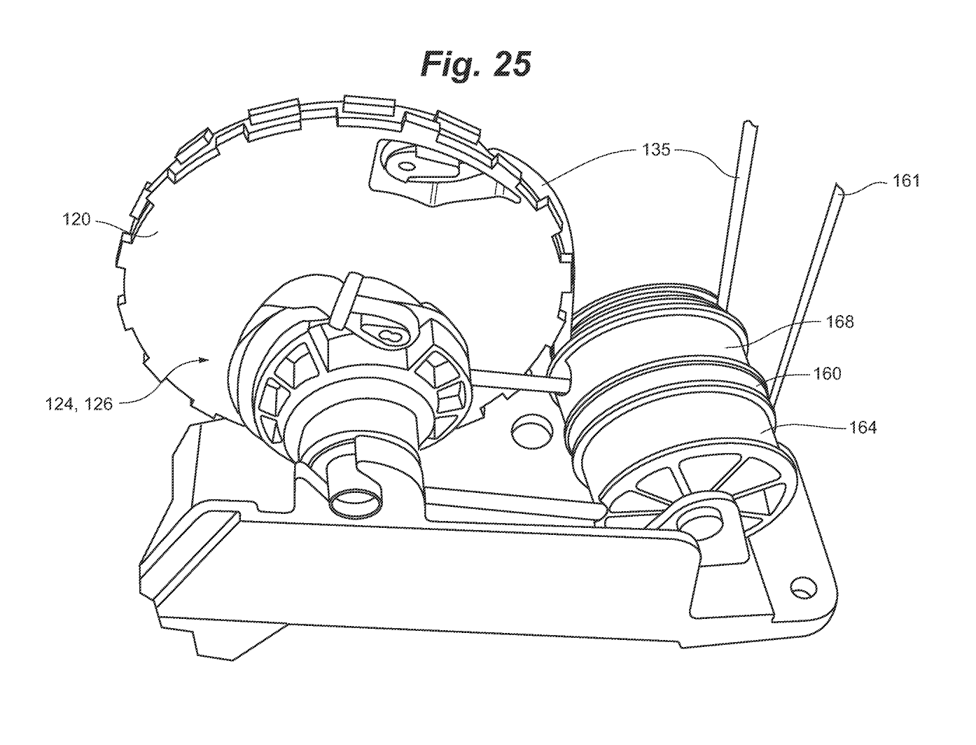

In use, when an operator desires to change the position of a monitor or other device supported by the apparatus 300, the operator can apply a force to the monitor and/or notebook. Movement of the monitor causes the mounting portion 350 of the support, to which it is attached, to also move relative to the support column 312 of the apparatus. FIG. 25 is a perspective view of a portion of the balance mechanism 116 in a state corresponding to the low position of mounting portion 350, while FIG. 26 is a perspective view of a portion of balance mechanism 116 in a state corresponding to the high position of mounting portion 350. As is shown, the mounting portion 350 is attached to the wheel pulley 120 via flexible element 135, so that movement of the monitor/notebook causes the wheel 120 to turn about its axis. The first and second cams 124, 126, which are attached to the wheel 120, also rotate and cause the cam pulleys 164, 168 and energy storage member pulley 160 to rotate about their respective axes (which in this case are the same axis). Rotation of the energy storage member pulley member 160 pulls or loosens flexible element 161, causing the energy storage member 144 to contract or allowing the member to expand in length. Since the shape of the cams 124, 126 are designed to accommodate a changing energy storage member force (e.g., based on spring length), the operator only need apply a relatively constant force to overcome friction to move the monitor to any desired position, and the monitor will stay in the desired position without having to lock it into that positions.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit and scope of the invention.

What is claimed is:

1. An apparatus for positioning an electronic display, comprising:
a riser comprising a support column and a bracket movably coupled together and a first lift mechanism coupled between the support column and the bracket;
a display mount coupled to the riser and adapted to support an electronic display; and
a movement mechanism coupling the display mount to the riser;
wherein relative movement between the bracket and the support column provides simultaneous height adjustment of the movement mechanism and the display mount;
wherein, at each height provided by the riser, the display mount is configurable in a first configuration providing a generally horizontal viewing configuration and a second configuration providing a generally declining viewing configuration;
wherein the movement mechanism provides the display mount with a first position relative to the riser, wherein the movement mechanism and the display mount provide a supported electronic display in the first position with a maximum backward tilt to provide the generally horizontal viewing configuration;
wherein the movement mechanism provides the display mount with a second position relative to the riser, wherein the movement mechanism and the display mount provide a supported electronic display in the second position with a maximum backward tilt of at least 30 degrees to provide the generally declining viewing configuration; and
wherein the maximum backward tilt in the first position is smaller than the maximum backward tilt in the second position.

2. The apparatus of claim 1, wherein the maximum backward tilt in the first position is about 20 degrees.

3. The apparatus of claim 1, wherein the display mount is a greater distance from the riser in the second position than in the first position.

4. The apparatus of claim 1, wherein the display mount is substantially the same distance from the riser in the second position and the first position.

5. The apparatus of claim 1, wherein the display mount is adapted to support a touch-sensitive electronic display of a tablet computer.

6. The apparatus of claim 1, further comprising a keyboard tray coupled to the riser and adapted to support a keyboard, wherein relative movement between the bracket and the support column provides simultaneous height adjustment of the movement mechanism, the display mount, and the keyboard tray.

7. The apparatus of claim 6, wherein in the second configuration a vertical distance between the display mount and the keyboard tray is different than in the first configuration.

8. The apparatus of claim 7, wherein in the second configuration the vertical distance between the display mount and the keyboard tray is less than in the first configuration.

9. The apparatus of claim 1, wherein the movement mechanism and the display mount are coupled to the bracket, and wherein the bracket is movable relative to the support column to provide the height adjustment.

10. The apparatus of claim 1, wherein the movement mechanism and the display mount are coupled to the support column, and wherein the support column is movable relative to the bracket to provide the height adjustment.

11. The apparatus of claim 10, wherein the riser comprises a bottom end and a top end and wherein the movement mechanism comprises a pivot attached to the riser proximate the top end of the riser.

12. The apparatus of claim 11, wherein the movement mechanism further comprises a display lift mechanism coupled between the pivot and the display mount.

13. The apparatus of claim 1, wherein the second position is lower relative to the riser than the first position.

14. The apparatus of claim 1, wherein the second position is higher relative to the riser than the first position.

15. The apparatus of claim 1, wherein the riser simultaneously adjusts the height of the movement mechanism and the display mount between a sitting height and a standing height.

16. An apparatus for positioning an electronic display and a keyboard, comprising:
a riser comprising a support column and a bracket movably coupled together and a first lift mechanism coupled between the support column and the bracket;
a display mount coupled to the riser and adapted to support an electronic display;
a keyboard tray coupled to the riser and adapted to support a keyboard; and
a movement mechanism coupling the display mount to the riser;
wherein relative movement between the bracket and the support column provides simultaneous height adjustment of the movement mechanism, the display mount, and the keyboard tray;
wherein at each height provided by the riser, the movement mechanism provides the display mount with a first position relative to the riser in a first configuration, wherein the movement mechanism and the display mount provide a supported electronic display in the first position with a maximum backward tilt to provide a generally horizontal viewing configuration; and
wherein at each height provided by the riser, the movement mechanism provides the display mount with a second position relative to the riser in a second configuration, wherein the movement mechanism and the display mount provide a supported electronic display in the second position with a maximum backward tilt to provide a generally declining viewing configuration, the maximum backward tilt in the second position being greater than the maximum backward tilt in the first position.

17. The apparatus of claim 16, wherein the movement mechanism guides the display mount toward the keyboard tray from the first position to the second position.

18. The apparatus of claim 16, wherein the movement mechanism guides the display mount away from the keyboard tray from the first position to the second position.

19. The apparatus of claim 16, further comprising a keyboard riser coupled between the keyboard tray and the riser, the keyboard riser providing the keyboard tray with a range of height adjustment relative to the display mount.

20. The apparatus of claim 16, wherein the maximum backward tilt in the second position is at least thirty degrees.

21. The apparatus of claim 16, wherein the maximum backward tilt in the first position is less than about twenty degrees.

22. The apparatus of claim 16, wherein the movement mechanism tilts the display mount as the display mount is moved between the first position and the second position.

23. The apparatus of claim 16, wherein the movement mechanism includes a pivoting arm.

24. The apparatus of claim 16, wherein the movement mechanism comprises a two-bar arm or a four-bar arm.

25. The apparatus of claim 16, wherein the movement mechanism comprises a rail attached to the riser and a bracket coupled between the rail and the display mount, the rail extending down and away from the riser.

26. The apparatus of claim 16, wherein the movement mechanism includes a mount portion coupled to the riser and an arm rotatably coupled to the mount portion such that the arm rotates about 180 degrees between the first position and the second position.

27. The apparatus of claim 16, wherein the movement mechanism includes a mounting bracket coupled to the riser, a pivot located at an end of the mounting bracket, and an arm coupled between the pivot and the display mount, wherein the pivot is positioned higher than the display mount in the first position and in the second position.

28. The apparatus of claim 16, wherein the movement mechanism includes a pivot portion attached to the riser and a lift mechanism coupled between the pivot portion and the display mount.

29. The apparatus of claim 16, wherein the riser simultaneously adjusts the height of the movement mechanism, the display mount, and the keyboard tray between a sitting height and a standing height.

30. The apparatus of claim 16, wherein the height adjustment of the movement mechanism, the display mount, and the keyboard tray is at least about 14 inches.

31. The apparatus of claim 16, wherein the height adjustment is between about 14 inches and about 24 inches.

32. The apparatus of claim 16, further comprising a work surface coupled to the riser, wherein the riser provides height adjustment of the work surface simultaneously with the movement mechanism, the display mount, and the keyboard tray.

33. The apparatus of claim 16, further comprising a tilt mechanism coupled between the movement mechanism and the display mount.

34. The apparatus of claim 16, wherein the movement mechanism, the display mount, and the keyboard tray are coupled to the support column, and wherein the support column is movable relative to the bracket to provide the height adjustment.

35. The apparatus of claim 16, wherein the movement mechanism, the display mount, and the keyboard tray are coupled to the bracket, and wherein the bracket is movable relative to the support column to provide the height adjustment.

36. The apparatus of claim 16, wherein the first lift mechanism comprises a balance mechanism comprising a cam and an energy storage member.

37. The apparatus of claim 36, wherein the cam comprises a dual cam.

38. An apparatus for positioning an electronic display and a keyboard, comprising:
a riser;
a display mount coupled to the riser and adapted to support an electronic display;
a keyboard tray coupled to the riser and adapted to support a keyboard; and
a movement mechanism coupling the display mount to the riser;
wherein the riser provides simultaneous height adjustment of the movement mechanism, the display mount, and the keyboard tray between a sitting height and a standing height;
wherein, at each of at least two heights provided by the riser, the display mount and the keyboard tray are configurable in a first configuration providing a generally horizontal viewing configuration and a second configuration providing a generally declining viewing configuration;
wherein in the second configuration a vertical distance between the display mount and the keyboard tray is different than in the first configuration; and
wherein the movement mechanism provides the display mount with a first position relative to the riser in the first configuration and a second position relative to the riser in the second configuration, wherein in the second position the display mount and a supported electronic display are able to tilt back from a vertical orientation to a greater degree than is available in the first position.

39. A method for positioning an electronic display and a keyboard, comprising:
supporting an electronic display with a positioning apparatus, the positioning apparatus comprising a riser, a display mount coupled to the riser and adapted to support the electronic display, a keyboard tray coupled to the riser, and a movement mechanism coupled between the riser and the display mount;
supporting a keyboard with the keyboard tray;
adjusting the riser to simultaneously adjust a height of the display mount, the electronic display, the keyboard tray, the keyboard, and the movement mechanism between a sitting position and a standing position; and
at each of the sitting position and the standing position, configuring the display mount and the keyboard tray in a first configuration providing a generally horizontal viewing configuration and a second configuration providing a generally declining viewing configuration;
wherein in the second configuration a vertical distance between the display mount and the keyboard tray is less than in the first configuration; and
wherein the movement mechanism provides the display mount with a first position relative to the riser in the first configuration and a second position relative to the riser in the second configuration, wherein in the second position the display mount and the electronic display can tilt back from a vertical orientation to a greater degree than in the first position.

40. A method for positioning an electronic display, comprising:
supporting an electronic display with the positioning apparatus of claim 1, comprising supporting the electronic display with the display mount;
simultaneously moving the electronic display and the movement mechanism between a sitting position and a standing position relative to a support member; and
adjusting the display mount between the first configuration and the second configuration.

41. A method for positioning an electronic display and a keyboard, comprising:
supporting an electronic display with the positioning apparatus of claim 16, comprising supporting the electronic display with the display mount and supporting the keyboard with the keyboard tray;
simultaneously moving the electronic display, the keyboard, and the movement mechanism between a sitting position and a standing position relative to a support member; and
adjusting the display mount and the keyboard tray between the first configuration and the second configuration.
